SEQUENCE LISTING (2 sequences)

SEQ ID NO: 1 - protein, 174 aa, Artificial Sequence
  synthetic granulocyte stimulating protein
TPLGPASSLPQSFLLKCLEQVRKIQGDGAALQEKLCATYKLCHPEELVLLGHSLGIPXAPLSSCPSQALQLAGCLSQLHSGLFLYQGLLQALEGISPELGPTLDTLQLDVADFATTIWQQXEELGXAPALXPXQGAMPAFASAFQRRAGGVLVASHLQSFLEVSYRVLRHLAQP

SEQ ID NO: 2 - protein, 174 aa, Artificial Sequence
  synthetic granulocyte stimulating protein
TPLGPASSLPQSFLLKXLEQVRKIQGDGAALQEKLCATYKLCHPEELVLLGHSLGIPXAPLSSCPSQALQLAGCLSQLHSGLFLYQGLLQALEGISPELGPTLDTLQLDVADFATTIWQQXEELGXAPALXPXQGAMPAFASAFQRRAGGVLVASHLQSFLEVSYRVLRHLAQP

(19) United States
(12) Patent Application Publication
(10) Pub. No.: US 2006/0275768 A1
(43) Pub. Date: Dec. 7, 2006

(54) Multiplex polymer ligation

(76) Inventors: Gerd G. Kochendoerfer, Oakland, CA (US); Haiyan Shao, Foster City, CA (US); Sonya Cressman, Ladysmith (CA)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/541,257

(22) PCT Filed: Dec. 30, 2003
(86) PCT No.: PCT/US03/41459

§ 371 Date: Jan. 9, 2006

Related U.S. Application Data
(60) Provisional application No. 60/437,511, filed on Dec. 30, 2002.
(60) Provisional application No. 60/515,609, filed on Oct. 29, 2003.

(51) Int. Cl. C40B 30/06; C40B 40/08; C40B 40/10

(52) U.S. Cl. 435/6; 435/7.1; 530/409

(57) ABSTRACT

The invention concerns a multiplex polymer ligation method involving water-soluble polymeric protecting groups, compositions and methods of use. The method involves synthesis of a first compound bearing one or more water-soluble polymeric protecting groups followed by replacing one or more of the water-soluble protecting groups with a chemical adduct of interest. Multiple different compounds derived from the first compound can be readily prepared by splitting the first compound into first and second reaction systems, followed by replacing one or more of the water-soluble polymeric protecting groups of the first reaction system with a first chemical adduct, and replacing one or more of the water-soluble polymeric protecting groups of the second reaction system with a second chemical adduct of interest, where the first and second chemical adducts are different. Also provided are kits useful for carrying out the multiplex polymer ligation methods of the invention.

### CROSS-REFERENCE TO RELATED APPLICATIONS

This application claims the benefit of U.S. provisional application Ser. No. 60/437,511, filed Dec. 30, 2002; and the benefit of U.S. provisional application Ser. No. 60/515,609, filed Oct. 29, 2003, each of which are incorporated herein by reference in their entireties.

### TECHNICAL FIELD OF THE INVENTION

The invention relates to water-soluble protecting groups and their use in the construction of chemically modified compounds, including multiplex approaches for the construction of diversity libraries and methods of production and use.

### BACKGROUND OF THE INVENTION

The synthesis of compounds presents several challenges. Intermediate components are typically required in high concentrations in order for a reaction to proceed cleanly, efficiently, and to minimize unwanted side reactions. At higher concentrations, many intermediates can become more or less insoluble. In some instances, a desired reaction component can exhibit poor handling properties even at low concentrations. Thus a delicate balance of concentration and solubility can influence the rate, quality and yield of a reaction.

Synthesis of compounds typically proceeds under organic, aqueous, or mixed organic-aqueous solvent conditions. Solvent systems are one of the primary factors that can be manipulated to alter the reaction and handling properties of the reaction components. Many different solvent systems and conditions are available for organic synthesis schemes. Unfortunately, similar systems for aqueous or mixed aqueous-organic synthesis schemes are limited, and thus the presence of intermediates with poor handling properties can be a problem. This is particularly true for the aqueous or mixed aqueous-organic synthesis schemes employed for the construction or chemical modification of biological compounds, such as lipids, carbohydrates, nucleic acids, peptides and polypeptides (including proteins).

Another problem with the synthesis of compounds in aqueous or mixed aqueous-organic synthesis schemes occurs when protecting group strategies are employed. For instance, protecting groups are typically used to help avoid side reactions with functional groups that would otherwise be present but for the protecting groups. A drawback is that most protecting groups have limited solubility in aqueous or mixed aqueous-organic solvent systems, and their use can have either no effect or further diminish the desired handling properties of intermediates or reaction products, particularly for biological compounds. As an example, while most peptides and polypeptides are soluble under aqueous conditions, they may still exhibit poor handling properties at higher concentrations, and can be difficult to chemically modify in precise ways unless protecting group strategies are employed. Unfortunately, fully protected or partially protected peptides or polypeptides can be insufficiently soluble in aqueous, so harsher solvent conditions are required to keep them in solution for reaction or chemical modification.

The challenges of compound synthesis also make it is desirable to obtain the most out of each reaction step or cycle. This is particularly important when making libraries of compounds having similar core structural features, and even more important where the compounds and intermediates are difficult or time consuming to make. Thus, the ability to generate diversity in a compound library from common intermediates quite often is desired. However, common reaction components and diversity elements that provide the variation from compound to compound in a given library can alter the solubility properties among the compounds, and requires differential conditions for their synthesis and manipulation. This can slow down the library synthesis process, make it more expensive or prevent access to some compounds altogether.

Accordingly, a need exists for improved methods in the synthesis of chemically modified compounds, particularly for synthesis methods carried out in aqueous or mixed aqueous-organic systems. Also, a need exists for the rapid synthesis of diverse compounds libraries that employ common intermediates with poor handling properties in aqueous or mixed aqueous-organic systems. The present invention addresses these and other needs.

### SUMMARY OF THE INVENTION

The invention concerns water-soluble protecting groups and their use in a multiplex polymer protection-ligation approach for the construction of chemically modified compounds, methods of manufacture and uses. In particular, the invention is directed to a method of producing a chemically modified compound. This method involves: (a) providing a compound bearing one or more water-soluble protecting groups, where the water-soluble protecting group comprises a water-soluble polymer; and (b) replacing one or more of the water-soluble protecting groups of the compound with a chemical adduct to form a chemically-modified compound. The compound and/or chemical adduct may be any number of molecule types, such as a lipid, carbohydrate, nucleic acid, amino acid, peptide, polypeptide, protein or synthetic polymer.

The invention also is directed to a method of producing a library of chemically modified compounds. This method includes: (a) providing a compound bearing one or more water-soluble protecting groups, where the water-soluble protecting group comprises a water-soluble polymer; (b) splitting the compound into first and second reaction systems; and (c) replacing one or more of the water-soluble protecting groups of the compound in the first reaction system with a first chemical adduct to form a first chemically-modified compound, and optionally, replacing one or more of the water-soluble protecting groups of the compound in the second reaction system with a second chemical adduct to form a second chemically modified compound, where the first and second chemical adducts are different.

Also provided is a method for producing a chemically modified, ligated polypeptide chain. This method involves the steps of: (a) providing a first peptide segment bearing one or more water-soluble protecting groups, where the water-soluble protecting group comprises a water-soluble polymer; (b) chemically ligating the first peptide segment to a second peptide segment to form a ligated polypeptide chain bearing one or more of the water-soluble protecting groups; and (c) replacing one or more of the water-soluble protecting groups with a chemical adduct to form a chemically-modified ligated polypeptide chain.

The invention further includes a method of producing a library of chemically modified ligated polypeptide chains. This method involves: (a) providing a first peptide segment bearing one or more water-soluble protecting groups, where the water-soluble protecting group includes a water-soluble polymer; (b) chemically ligating the first peptide segment to a second peptide segment to form a ligated polypeptide chain bearing one or more of the water-soluble protecting groups; (c) splitting the ligated polypeptide chain composition into first and second reaction systems; and (d) replacing one or more of the water-soluble protecting groups of the ligated polypeptide chain in the first reaction system with a first chemical adduct to form a first chemically-modified ligated polypeptide chain, and, optionally, replacing one or more of the water-soluble protecting groups of the ligated polypeptide chain in the second reaction system with a second chemical adduct to form a second chemically-modified ligated polypeptide chain, wherein the first and second chemical adducts are different.

The invention also is directed to kits for performing one or more methods of the invention. This aspect of the invention includes a kit having first and second containers, where the first container includes a compound bearing one or more water-soluble protecting groups, and where the water-soluble protecting group comprises a water-soluble polymer. The second container includes a chemical adduct that is capable of replacing one or more of the water-soluble protecting groups of the compound in the first container. The kit may further include instructions as well as other components, reagents and the like.

The methods of the invention provide substantive flexibility in that a compound of interest can be modified to contain one, or two or more water-soluble polymeric protecting groups. Also, the polymeric water-soluble protecting groups may be joined to the compound through the same or different linkages. An advantage of using the same linkages for compounds bearing two or more water-soluble polymeric protecting groups is that the replacement reaction will generate compounds bearing the same residual groups at the site of cleavage/replacement of the water-soluble protecting group polymer. Thus, functional groups on a target molecule can be generated to react with the same or different chemical adducts, provided the chemical adducts bear a mutually reactive functional group that is capable of forming a covalent bond with the residual functional group on the compound.

Another advantage of the invention is that a compound that is modified with one or more water-soluble polymeric protecting groups exhibits better handling properties compared to the non-polymer modified versions. This aids in production and overall yield of the precursors. Another advantage of the invention is that multiple analogs of a given target can be prepared in a split synthesis reaction by taking one or more precursor targets that have the same or similar core structure, splitting the precursor(s) into separate reactions, and then rapidly expanding the diversity of the precursor target to generate a final target through the addition of different chemical adducts designed to replace the one or more of the water-soluble polymeric protecting groups.

These and other advantages, and features of the invention will become apparent to those persons skilled in the art upon reading the details of the invention as more fully described below.

### BRIEF DESCRIPTIONS OF THE DRAWINGS

FIG. 1 is a schematic illustrating a multiplex polymer ligation method of the invention.

FIG. 2 is a schematic illustrating a synthesis scheme of the exemplary synthetic neutropoiesis stimulating proteins SGP-A, SGP-B, and SGP-D using a multiplex polymer ligation method of the invention.

FIG. 3 is a schematic illustrating the structure of the exemplary synthetic neutropoiesis stimulating protein SGP-A (SEQ ID NO:1).

FIG. 4 is a schematic illustrating the structure of the exemplary synthetic neutropoiesis stimulating protein SGP-B (SEQ ID NO:2).

FIG. 5 is a schematic illustrating the structure of the exemplary synthetic neutropoiesis stimulating protein SGP-D (SEQ ID NO:2).

It is to be understood that the invention described herein is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a synthetic neutropoiesis stimulation protein” includes a plurality of such synthetic neutropoiesis stimulation proteins and reference to “the synthetic neutropoiesis stimulation protein” includes reference to one or more synthetic neutropoiesis stimulation protein and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DETAILED DESCRIPTION OF THE INVENTION

The present invention relates to multiplex polymer-protection and ligation, its use in the synthesis of chemically-modified compounds and related uses thereof.

In one embodiment, the invention is directed to a method of producing a compound that is modified with a chemical adduct. This method involves (a) providing a compound having one or more water-soluble protecting groups, where the water-soluble protecting group includes a water-soluble polymer; and (b) replacing one or more of the water-soluble protecting groups of the compound with a chemical adduct to form a chemically-modified compound. The compound and/or chemical adduct may any number of types of molecule, such as a lipid, carbohydrate, nucleic acid, amino acid, peptide, polypeptide, protein or synthetic polymer.

Replacement of the water-soluble protecting group with a chemical adduct of interest is afforded by the presence and cleavage of a cleavable linker that attaches the water-soluble protecting group to the compound of interest. The cleavable linker can be any one of numerous linkers, the selection of which depends on the intended end use. For instance, the linker can be one that is cleavable by physical conditions (e.g., a photolabile linker that is cleaved by light), chemical conditions (e.g., a chemically linker that is cleaved by an organic reagent such as an acid, base or other chemical reagent), biologic conditions (e.g., a peptide, carbohydrate, lipid, or nucleic acid linker that is cleaved by an enzyme such as a protease, glycosidase, lipase or nucleic acid restriction enzyme), or combinations thereof.

In a preferred embodiment, the linker and cleavage conditions employed are selected to generate a residual functional group on the compound at the site of cleavage that is capable of reacting with a mutually reactive functional group on the chemical adduct. Most preferably, the linker and cleavage conditions employed will generate a residual functional group on the compound at the site of cleavage that is unique relative to other functional groups present on the compound. Where the compound contains one or more similar or identical functional groups relative to a functional group generated by the cleavage reaction, and it is desirable to keep such functional groups from reacting with the chemical adduct, such chemical groups can be protected with a protecting group that is removable under conditions different from the cleavage reaction that removes the water-soluble protecting group, i.e., use of orthogonal protecting group strategies.

In a preferred embodiment, the chemical adduct is chosen so as to uniquely react with a residual functional group on the compound generated by the cleavage reaction. Most preferably, the water-soluble protecting group is attached to the compound through a cleavable linker having a covalent bond that is displaceable by the chemical adduct. Examples of suitable displaceable covalent bonds are oxime, hydrazone, diol, thioester, selenoester and disulfide bonds. Thus, for instance, when the covalent bond is an oxime, the chemical adduct may include a reactive functional group such as an aminooxy, aldehyde, or ketone. When the covalent bond is a hydrazone, the chemical adduct may include a reactive functional group such as a hydrazide. When the covalent bond is a disulfide, diselonide, or mixed disulfide/selonide, the chemical adduct may include a reactive functional group such as a thiol or selenol. It should be noted that when using displaceable linker systems, the direction of the bond is taken into consideration so that the incoming chemical adduct will be able to form/replace the original covalent bond.

One or more excipients may be employed to catalyze or otherwise promote the desired replacement reaction. Preferred excipients are scavengers and/or compounds that promote an equilibrium reaction with an incoming chemical adduct. In particular, excipients can be employed where formation of the bond between the chemical adduct and the compound is favored as compared to formation/re-formation of the bond between the water-soluble polymeric protecting group and the compound. For instance, where the water-soluble protecting group polymer is joined to the compound via a displaceable oxime linker, an aminooxy compound such as aminooxy acetic acid may be added as a scavenger and/or equilibrium driver to aid in keeping an oxime bond from re-forming between the compound and the protecting group. Thiol or selenol compounds, such as thiophenol,: selenophenol, mercaptans and the like can be employed where the water-soluble protecting group polymer is attached to the compound via disulfide, diselonide, mixed disulfide/selenide, thioester or selenoester. Hydrizides for hydrazone linkages, diols for diol linkages etc. can be employed in a similar fashion. Other excipients include salts, buffers, chaotropes, denaturants, detergents and the like. Of course a given excipient or combination of excipients, their concentration, extent of exposure and the like can be determined by routine testing to design and optimize a particular reaction relative to a compound of interest. Physical conditions such as pH, light and temperature may also be optimized in a similar fashion following standard matrix type approaches.

With respect to the water-soluble polymeric protecting group, the polymer component will preferably include a repeat unit comprising a polyalkylene oxide, a polyamide alkylene oxide, or derivatives thereof. Most preferably, the polyalkylene oxide and polyamide alkylene oxide include an ethylene oxide repeat unit of the formula —(CH2-CH2-O)—. The water-soluble protecting group may be linear or branched, including dendrimer structures. In a preferred embodiment, the water-soluble protecting group will have a net charge under physiological conditions. Depending on the construct employed, the net charge can be positive, neutral or negative. The most preferred water-soluble protecting group polymers of the invention are mono-disperse, i.e., a single molecular species as distinguished from hetero-disperse compounds composed of multiple different molecular species. Utilization of a mono-disperse water-soluble protecting group polymer has the advantage of permitting the construction of compounds that also are mono-disperse.

In a preferred embodiment, the compound will comprise two or more water-soluble protecting groups. The water-soluble protecting groups may be joined to the compound through the same or different linkages. An advantage of using the same linkages is that the replacement reaction will generate compounds bearing the same residual groups at the site of cleavage of the water-soluble protecting polymeric group. Thus, functional groups can be generated on the compound of interest to react with the same or different chemical adducts, provided the chemical adducts bear a mutually reactive functional group that is capable of forming a covalent bond with the residual functional group on the compound that is generated by removal of the water-soluble polymeric protecting group.

In another embodiment of the invention, a method is provided for producing a library of chemically modified compounds. This method includes (a) providing a compound bearing one or more water-soluble protecting groups, where the water-soluble protecting group comprises a water-soluble polymer; (b) splitting-the compound into first and second reaction systems; and (c) replacing one or more of the water-soluble protecting groups of the compound in the first reaction system with a first chemical adduct to form a first chemically-modified compound. Thus, the original compound bearing one or more water-soluble protecting groups is made in conjunction with a first chemically modified compound. For additional diversity, this method can optionally include replacing one or more of the water-soluble protecting groups of the compound in the second reaction system with a second chemical adduct to form a second chemically modified compound, where the first and second chemical adducts are different.

In another preferred embodiment, the invention is directed to a method of producing a chemically-modified ligated polypeptide chain. This method involves the steps of (a) providing a first peptide segment bearing one or more water-soluble protecting groups, where the water-soluble protecting group comprises a water-soluble polymer; (b) chemically ligating the first peptide segment to a second peptide segment to form a ligated polypeptide chain bearing one or more of the water-soluble protecting groups; and (c) replacing one or more of the water-soluble protecting groups with a chemical adduct to form a chemically-modified ligated polypeptide chain. While the peptide segments can have the same or similar amino acid sequences, they will preferably comprise non-overlapping amino acid sequences of a polypeptide chain target. In a preferred embodiment, the polypeptide chain comprises an amino acid sequence of a protein. Thus, the method may further include folding of the polypeptide chain to form a protein. For ligation, one or more of the peptide segments can be partially protected with protecting groups other than the water-soluble protecting group polymer. Alternatively, one or more of the peptide segments can be unprotected, i.e., missing protecting groups other than the water-soluble protecting group polymer. The ligation methods may employ any chemoselective ligation chemistry capable of ligating unprotected peptides in aqueous solution. Preferred ligation methods are selected from native chemical ligation, extended native chemical ligation, pseudo native chemical ligation, oxime forming chemical ligation, hydrazone forming chemical ligation, oxazolidine forming chemical ligation, thaizolidine forming chemical ligation, and thioester forming chemical ligation.

In another preferred embodiment, the invention is directed to a method of producing a library of chemically-modified ligated polypeptide chains. This method involves: (a) providing a first peptide segment bearing one or more water-soluble protecting groups, where the water-soluble protecting group includes a water-soluble polymer; (b) chemically ligating the first peptide segment to a second peptide segment to form a ligated polypeptide chain bearing one or more of the water-soluble protecting groups; (c) splitting the ligated polypeptide chain composition into first and second reaction systems; and (d) replacing one or more of the water-soluble protecting groups of the ligated polypeptide chain in the first reaction system with a first chemical adduct to form a first chemically-modified ligated polypeptide chain, and, optionally, replacing one or more of the water-soluble protecting groups of the ligated polypeptide chain in the second reaction system with a second chemical adduct to form a second chemically-modified ligated polypeptide chain, wherein the first and second chemical adducts are different.

Also provided are kits for performing one or more methods of the invention. In particular, the invention is directed to a kit comprising first and second containers. In this embodiment, the first container includes a compound bearing one or more water-soluble protecting groups, where the water-soluble protecting group comprises a water-soluble polymer. The second container includes a chemical adduct that is capable of replacing one or more of the water-soluble protecting groups of the compound in the first container. The kit may further include instructions as well as other components, reagents and the like.

As noted above, the water-soluble polymeric protecting groups employed in the invention can be exploited to render a target compound or intermediate thereof of interest soluble in water, as well as to generate libraries of compounds that are chemically modified with one or more chemical adducts of interest, such as a lipid, carbohydrate, nucleic acid, amino acid, peptide, polypeptide, protein or synthetic polymer. By “water-soluble polymeric protecting group” is intended a polymer that is soluble in water and is removable under chemically defined conditions. Preferred water-soluble polymers, including those utilized for the water-soluble polymeric protecting groups of the invention are those described in PCT Publication Nos. WO 02/19963 and WO 02/20033. Briefly, these water-soluble polymers can be represented by the formula:
Un-si-B-s2-Polymer-s3-J*
U is a residue of a unique functional group that is capable bonding with, or is covalently bonded to a target compound of interest. In particular, the U group is capable bonding with, or is bonded to a mutually reactive unique functional group n of one or more sites on a target compound of interest, such as a peptide segment of a peptide or protein, and where n is a discrete integer from 1 to 6. More preferably n is a discrete integer from 1 to 4, and most preferably from 1 to 2. Exemplary processes of forming the polymers suitable for use in the invention are illustrated in PCT Publication Nos. WO 02/20033 and WO 02/19963.

Preferred embodiments of U and n are covalent bonds formed from unique mutually reactive groups, where such bonds are selected from oxime, amide, amine, urethane, ether, thioether, ester, hydrazide, oxazolidine, thaizolidine, thioether, ether, and ester. The most preferred U and n bond is one where U is covalently bonded to n through a bond formed by chemical ligation selected from the group consisting of amide, oxime, thioester, hydrazone, thaizolidine, and oxazolidine. For use as a removable protecting group, the most preferred U and n bond is one where U is covalently bonded to n through a bond formed by chemical ligation selected from the group consisting of oxime, thioester, hydrazone, thaizolidine, and oxazolidine, where the oxime, thioester, hydrazone, thaizolidine, or oxazolidine that is formed is capable of being cleaved or otherwise displaced in a reaction that regenerates functional group n. The regenerated functional group n can then be utilized for subsequent modification with a chemical adduct of interest.

B is a branching core having three or more arms that may be the same or different and may be present or absent, Most preferably B is present and-comprises at three or more arms. In particular, one arm of B is joined to U (optionally through a spacer or linker s1), and a second arm of B is joined to Polymer (optionally through a spacer or linker s2). A favored polymer construct is one in which at least one of the branching arms of moiety B comprises a residue of bond selected from the group consisting of oxime, amide, amine, urethane, thioether, ester, hydrazide, oxazolidine, and thaizolidine. A preferred branching group B comprises a branching core selected from the group consisting of amino, carboxylate and mixed amino-carboxylate. Preferred amino branching core comprise lysine, preferred carboxylate branching core comprise glutamic or aspartic acid, and preferred mixed amino-carboxylate branching core comprises gamma-glutamic acid, or derivatives thereof.

The Polymer component is a substantially water-soluble polymer that may be the same or different where B is present. By “water-soluble polymer” is intended a polymer that is soluble in water and has an atomic molecular weight greater than about 200 Daltons (Da). When employed as a protecting group, the Polymer will preferably have an effective hydrodynamic molecular weight of greater than 500 Da, and more preferably about 800 to 20,000 Da, and most preferably about 800 to 10,000 Da. By “effective-hydrodynamic molecular weight” is intended the effective water-solvated size of a polymer chain as determined by aqueous-based size exclusion chromatography (SEC). When the water-soluble polymer contains polymer chains having polyalkylene oxide repeat units, such as ethylene oxide repeat units, it is preferred that each chain have an atomic molecular weight of between about 200 and about 5000 Da and preferably between about 300 and about 3000 Da, with 500 to about 1000 Da being most preferred. The smaller molecular weight water-soluble polymeric protecting groups are advantageous to the extent that the intermediates or target compound to which they are attached not only have improved handling properties in aqueous solutions, but also can be separated/purified from other components after a given reaction at the like. Unless referred to specifically, molecular weight is intended to refer to atomic molecular weight.

Nevertheless, the Polymer component can have a wide range of molecular weight, and polymer subunits. These subunits may include a biological polymer, a synthetic polymer, or a combination thereof. Examples of such water-soluble polymers include: dextran and dextran derivatives, including dextran sulfate, P-amino cross linked dextrin, and carboxymethyl-dextrin; cellulose and cellulose derivatives, including methylcellulose and carboxymethyl cellulose, starch and dextrines, and derivatives and hydroylactes of starch, polyalklyene glycol and derivatives thereof, including polyethylene glycol, methoxypolyethylene glycol, polyethylene glycol homopolymers, polypropylene glycol homopolymers, copolymers of ethylene glycol with propylene glycol, wherein said homopolymers and copolymers are unsubstituted or substituted at one end with an alkyl group, heparin and fragments of heparin, polyvinyl alcohol and polyvinyl ethyl ethers, polyvinylpyrrolidone, aspartamide, and polyoxyethylated polyols, with the dextran and dextran derivatives, dextrine and dextrine derivatives. It will be appreciated that various derivatives of the specifically recited water-soluble polymers are also contemplated.

Water-soluble polymers such as those described above are well known, particularly the polyalkylene oxide based polymers such as polyethylene glycol “PEG” (See. e.g., “Poly(ethylene glycol) Chemistry: Biotechnical and Biomedical Applications”, J. M. Harris, Ed., Plenum Press, New York, N.Y. (1992); and “Poly(ethylene glycol) Chemistry and Biological Applications”, J. M. Harris and S. Zalipsky, Eds., ACS (1997); and International Patent Applications: WO 90/13540, WO 92/00748, WO 92/16555, WO 94/04193,WO 94/14758, WO 94/17039, WO 94/18247, WO 94/28937, WO 95/11924, WO 96/00080, WO 96/23794, WO 98/07713, WO 98/41562, WO 98/48837, WO 99/30727, WO 99/32134, WO 99/33483, WO 99/53951, WO 01/26692, WO 95/13312, WO 96/21469, WO 97/03106, WO 99/45964, and U.S. Pat. Nos. 4,179,337; 5;075,046; 5,089,261; 5,100,992; 5,134,192; 5,166,309; 5,171,264; 5,213,891; 5,219,564; 5,275,838; 5,281,698; 5,298,643; 5,312,808; 5,321,095; 5,324,844; 5,349,001; 5,352,756; 5,405,877; 5,455,027; 5,446,090; 5,470,829; 5,478,805; 5,567,422; 5,605,976; 5,612,460; 5,614,549; 5,618,528; 5,672,662; 5,637,749; 5,643,575; 5,650,388; 5,681,567; 5,686,110; 5,730,990; 5,739,208; 5,756,593; 5,808,096; 5,824,778; 5,824,784; 5,840,900; 5,874,500; 5,880,131; 5,900,461; 5,902,588; 5,919,442; 5,919,455; 5,932,462; 5,965,119; 5,965,566; 5,985,263; 5,990,237; 6,011,042; 6,013,283; 6,077, 939; 6,113,906; 6,127355; 6,177,087; 6,180,095; 6,194,580; 6,214,966).

The more preferred Polymer component comprises a polyalkylene oxide, polyamide alkylene oxide, or derivatives thereof. A more favored polyalkylene oxide and polyamide alkylene oxide comprise an ethylene oxide repeat unit of the formula —(CH2-CH2-O)—. An even more preferred Polymer component is a polyamide having a molecular weight greater than about 500 to 5000 Daltons of the formula —[C(O)—X—C(O)—NH—Y—NH]n- or —[NH—Y—NH—C(O)—X—C(O)]n-, where X and Y are divalent radicals that may be the same or different and may be branched or linear, and n is a discrete integer from 2-100, and more preferably from 2 to 50, and where either or both of X and Y comprises a biocompatible, substantially non-antigenic water-soluble repeat unit that may be linear or branched. The most preferred water-soluble repeat unit comprises an ethylene oxide of the formula —(CH₂—CH₂—O)— or —(CH₂—CH₂—O)—. The number of such water-soluble repeat units can vary significantly, but the more preferred number of such units is from 2 to 500, 2 to 400, 2 to 300, 2 to 200, 2 to 100, 2 to 50, 2 to 40, 2 to 30, 2 to 30, 2-10 and most preferably 2 to 6. An example of a more preferred embodiment is where one or both of X and Y is selected from: —((CH₂)ₙ₁—(CH₂—CH₂—O)ₙ₂—(CH₂)ₙ₁—)— or —((CH₂)ₙ₁—(O—CH₂—CH₂)ₙ₂—(CH₂)ₙ₁—), where n1 is 1 to 6, 1 to 5, 1 to 4 and most preferably 1 to 3, and where n2 is 2 to 50, 2 to 25, 2 to 15, 2 to 10, 2 to 8, 2 to 7, 2 to 6, 2 to 5, 2 to 4 and most preferably 2 to 3. An example of a highly preferred embodiment is where X is —(CH₂—CH₂)—, and where Y is —(CH₂—(CH₂—CH₂—O)₃—CH₂—CH₂—CH₂)— or —(CH₂—CH₂—CH₂—(O—CH₂—CH₂)₃—CH₂)—.

The Polymer component or one or more of the spacers or linkers, when present, may include polymer chains or units that are biostable or biodegradable. For example, Polymers with repeat linkages have varying degrees of stability under physiological conditions depending on bond lability. Polymers with such bonds can be categorized by their relative rates of hydrolysis under physiological conditions based on known hydrolysis rates of low molecular weight analogs, e.g., from less stable to more stable polycarbonates (—O—C(O)—O—)>polyesters (—C(O)—O—)>polyurethanes (—NH—C(O)—O—)>polyorthoesters (—O—C((OR)(R′))—O—)>polyamides (—C(O)—NH—). Similarly, the linkage systems attaching a water-soluble polymer to a target molecule may be biostable or biodegradable, e.g., from less stable to more stable carbonate (—O—C(O)—O—)>ester (—C(O)—O—)>urethane (—NH—C(O)—O—)>orthoester (—O—C((OR)(R′))—O—)>amide (—C(O)—NH—). These bonds are provided by way of example, and are not intended to limit the types of bonds employable in the polymer chains or linkage systems of the water-soluble polymers of the invention.

Component J* is a residue of pendant group having a net charge under physiological conditions selected from the group consisting of negative, positive and neutral. This includes alkyl, aryl, heteroalkyl, heteroaryl, arylalkyl, acyl, alkoxy, alkenyl, alkynyl, amideo, amino, carbonyl groups and the like, that are substituted or unsubstituted, and as well as salts thereof. Neutral groups preferably are alkyl or alkoxy groups, and can include, but are not limited to moieties containing from 1 to 18 carbons, and may be linear or branched. When provided as a charged group, J* comprise an ionizable functional group. Examples of functional groups include, but are not limited to, carboxylic acids, esters, amides, nitriles, thiols, and hydroxyls. Such J* groups may be a component of amino acids, nucleic acids, fatty acids, carbohydrates, and derivatives thereof, and moieties such as chitin, chitosan, heparin, heparan sulfate, chondroitin, chondroitin sulfate, dermatan and dermatan sulfate, cyclodextrin, dextran, hyaluronic acid, phospholipid, sialic acid and the like. J* preferably comprises an ionizable moiety selected from carboxyl, amino, thiol, hydroxyl, phosphoryl, guanidinium, imidazole and salts thereof. The most preferred is where J* comprises an ionizable carboxylate moiety and has a net positive or net negative charge under physiological conditions, as the presence of the charged group further aids in increasing solubility in water.

The components s1, s2, and s3 are spacer or linker moieties that may be the same or different, and may be individually present or absent. Preferred spacers or linkers include linear or branched moieties comprising one or more repeat units employed in a water-soluble polymer, diamino and or diacid units, natural or unnatural amino acids or derivatives thereof, as well as aliphatic moieties, including alkyl, aryl, heteroalkyl, heteroaryl, alkoxy, and the like, which preferably contain up to 18 carbon atoms or even an additional polymer chain. Most preferably the spacer or linker comprises a polymer chain.

Alternatively, the above formula Un-s1-B-s2-Polymer-s3-J* can be represented as “Un-B-Polymer-J*” where the s1, s2 and s3 groups may be present or absent.

The more preferred Polymer component is one where the water-soluble polymer U-s1-B-s2-Polymer-s3-J* is produced in total by stepwise synthesis. This permits construction of polymers having a precise molecular weight and defined structure. In contrast, normal polymer synthesis, which is a polymerization process, results in a mixture in which chains are of differing lengths, and so there is a distribution of molecular weights and sizes that are difficult if not impossible to separate. The ability to control molecular purity is advantageous in that a synthetic protein can be constructed that has a water-soluble polymer attached thereto and that is monodisperse. This represents a significant advantage in that variable properties resulting from heterogeneous compounds can be avoided, and only those compounds with the most preferred properties can be prepared and isolated with relative ease.

As noted above, water-soluble polymers that are made in total by stepwise assembly can be made as monodisperse, for example the preferred polyamide ethylene oxides of the invention. In accordance with this aspect of the invention, a solution to the above-identified problems of polymer heterogeneity and diversity involves the production of biocompatible polymers of the formula —[CO—X—CO—NH—Y—NH]n- which combine the advantages of both polypeptides (precise length, convenient synthesis) and “PLP” (“precision length polymer”), a flexible, amphiphilic, non-immunogenic, polymer not susceptible to proteases, Rose, K. et al. (U.S. patent application Ser. No. 09/379,297, herein incorporated by reference). Such PLP moieties can be synthesized in any of a variety of ways. Such moieties are, however, preferably produced using a solid phase stepwise chain assembly of units, rather than a polymerization process. The use of such an assembly process permits the moieties of a preparation to have a defined and homogeneous structure, as to their length, the nature of their X and Y substituents, the position(s) (if any) of branch points, and the length, X and Y substituents, and position(s) of any branches. Methods of particular interest for synthesis of such PLP moieties is described in, for example, PCT Publication Nos. WO 02/19963, WO 02/20033, and WO 00/12587.

Thus another preferred embodiment is one where the water-soluble polymer is mono-disperse (i.e., a molecularly homogenous composition containing a single and structurally defined molecular species of interest). Also, it is preferred that the compound targeted for modification with a water-soluble polymeric protecting group of the invention be mono-disperse as well, for example, as synthetic peptides and proteins can be made in total by chemical synthesis, they can be made mono-disperse as well. Such compounds have the advantage of being highly pure and avoid the problems of purification and analytical characterization as when hetero-disperse polymers are employed. Such compounds are advantageous in terms of reproducible analoging and the like as well (for example, a single molecular species as opposed to mixtures typical of PEGylated targets).

Accordingly, properties of the polymer-modified compounds of the invention can be modified by precisely adjusting the sites and linkage chemistries of polymer attachment in combination with the precision adjustment of the molecular weight, the polymer composition, the structure (e.g., linear versus branched, or mixtures thereof), and the pendant group (e.g., charged versus uncharged, or mixtures thereof) of the water-soluble polymer. In particular, in addition to increasing the water hydration and molecular weight of a protein to improve handling properties in aqueous solution, and branching etc., the water-soluble polymer attached thereto can render the target compound to have a precise charge, as measured by isoelectric point that can be adjusted for a given solution or solid phase system to modulate the handling properties and/or subsequent attachment of a target polymer. A preferred embodiment of the invention is thus directed to compounds and methods that combine the above features, as well as the water-soluble polymeric protecting groups utilized therefor, particularly structurally defined water-soluble protecting group polymers that are capable of being attached at pre-selected positions designed into a compound targeted for chemical modification, such as a one or more peptide segments employed in ligation reactions and for subsequent permanent chemical adduct modification.

As noted above, a preferred embodiment of the invention is directed to a method for producing a chemically modified, ligated polypeptide chain, and a method of producing a library of chemically modified ligated polypeptide chains. Both of these methods reply on the chemical ligation of peptide segments. In a preferred embodiment, the peptide or polypeptide is synthetic. A peptide or polypeptide (or protein) is said to be “synthetic” if non-recombinant technology has been employed to polymerize some, and most preferably all, of its amino acid residues. The term “non-recombinant technology” is intended to distinguish technologies that involve organic chemistry and other synthetic polymerization approaches from technologies involving the translation of RNA into protein, either in vivo or in vitro. Synthetic peptides and proteins include totally synthetic and semi-synthetic peptides and proteins. A totally synthetic peptide or protein is produced where all ligation components are man-made by chemical synthesis, i.e., ribosomal-free synthesis. A semi-synthetic peptide or protein is produced where at least part of a ligation component is made by biological synthesis, i.e., ribosomally in a cell or cell-free translation system, and another part is made by chemical synthesis. The synthetic peptides and proteins employed in the invention preferably include at least 5-10, 10-20, 20-25, 25-30, 30-35, 35-40, 40-45 or 45-50 chemically assembled amino acid residues, and more preferably include greater than 50, and even more preferably greater than 75 chemically assembled amino acid residues when the proteins are larger than 75 amino acids in length. Most preferably the amino acid residues of a synthetic peptide or protein employed with the methods of the invention will be assembled in total by chemical synthesis.

In a preferred embodiment, the synthetic peptides and proteins employed in the invention comprise a polypeptide chain having an amino acid sequence of a ribosomally specified protein, where the polypeptide chain comprises one or more non-overlapping peptide segments covalently bonded by one or more chemical ligation sites. By “chemical ligation site” is intended the N-terminal amino acid of a first peptide or polypeptide and the C-terminal amino acid of a second peptide or polypeptide that form or are capable of forming a non-reversible covalent bond therein between by chemical ligation. As used herein, “chemical ligation” refers to a chemoselective reaction involving the covalent joining of two chemical moieties, each of which moieties bears a mutually reactive functional group that is uniquely capable of forming a non-reversible covalent bond with the other. Chemical ligation includes covalent ligation of (1) a first peptide or polypeptide bearing a uniquely reactive C-terminal group with (2) a second peptide or polypeptide bearing a uniquely reactive N-terminal group, where the C-terminal and N-terminal reactive groups form a non-reversible covalent bond therein between. In particular, chemical ligation includes any chemoselective reaction chemistry that can be applied to ligation of unprotected peptide segments. Most preferably the ribosomally specified protein is mammalian, and more preferably human or derivatives thereof.

In another preferred embodiment, the synthetic peptides and proteins employed in the invention may include one or more non-genetically encoded amino acids or chemical groups. By “non-genetically encoded” is intended an amino acid that is other than one of the ribosomally installed 20 genetically encoded amino acids. For instance, in a preferred embodiment, the synthetic peptide and proteins of the invention will comprise one or more irregular amino acids. As used herein the term “amino acid” is intended to include the 20 genetically coded amino acids, rare or unusual amino acids that are found in nature, and any of the non-naturally occurring amino acids, such as irregular amino acids; sometimes referred to as amino acid residues when in the context of a peptide, polypeptide or protein. As used here, “irregular amino acid” refers to an amino acid having a non-genetically encoded side chain, a non-genetically encoded backbone, a non-genetically encoded substituted Nα or αC(O) moiety, or a combination thereof, i.e., other than one of the ribosomally installed 20 genetically encoded amino acids. Examples of preferred irregular amino acids include amino acids having side chains bearing a unique functional group other than a genetically encoded functional group, as well as pseudo amino acids and various amino acid derivatives. In this regard, the present invention permits wide selectability and flexibility in the design, construction and/or final composition of a particular synthetic peptide or protein of interest.

Examples of non-ribosomally installed amino acids that may be used in accordance with the invention include, but are not limited to: D-amino acids, β-amino acids, pseudo-glutamate, pseudo-glutamine, aminoisobutryate (Aib), aminobutyrate (Abu), norleucine, ornithine, homocysteine, N-substituted amino acids (R. Simon et al., Proc. Natl. Acad. Sci. U.S.A. (1992) 89: 9367-71; WO 91/19735 (Bartlett et al.), U.S. Pat. No. 5,646,285 (Baindur), α-aminomethyleneoxy acetic acids (an amino acid-Gly dipeptide isostere), and α-aminooxy acids and other amino acid derivatives having non-genetically non-encoded side chain function groups etc. Peptide analogs containing thioamide, vinylogous amide, hydrazino, methyleneoxy, thiomethylene, phosphonamides, oxyamide, hydroxyethylene, reduced amide and substituted reduced amide isosteres and β-sulfonamide(s) may be employed.

Additional non-genetically encodable chemical groups of particular interest are those comprising a chemical adduct of interest, including small molecules and polymers and the like, such as dyes, drugs, lipids, carbohydrates, nucleic acids, detectable markers, metal chelators, toxins, and water-soluble polymers. In one embodiment of particular interest, the synthetic peptides and proteins employed in the invention include small molecule adducts. Such small molecule adducts are preferably attached to the N— and/or C-terminus of the synthetic peptide or protein of interest. Such small molecule adducts include groups capable of forming a covalent bond to the N-terminal amino or C-terminal carboxyl group of an amino acid residue. Examples include, but are not limited to,.capping groups such as acyl, amide, and other amino acid capping groups, as well as methyl glycine (betaine), dimethyl glycine and other irregular amino acid analogs, and as well as acids such as succinic acid or other similar acids, depending on the intended end use. The attachment can be through any number of covalent bonds, including, but not limited to, amide, amino, ester, thioester, selenoester, ether, thioether, selenoether, Schiff-base (non-reduced or reduced) and the like. Inclusion of such groups may aid in protection of the N— and/or C-terminus from proteolytic degradation, and/or stability. They also may aid in improving the synthesis and handling properties, including solubility in aqueous solution and in aiding in the formulation of a pharmaceutical preparation and its application to a subject in need thereof.

Non-genetically encodable changes of particular interest are those that provide altered terminal and/or side-chain properties, and especially for the site-specific attachment-of a water-soluble polymeric protecting group or other chemical adducts of interest. For instance, small molecules and polymers and the like, such as dyes, drugs, lipids, carbohydrates, nucleic acids, detectable markers, metal chelators, toxins, and water-soluble polymers, are advantageously attached through non-genetically encodable chemical groups that bear functional reactive groups other than present on a genetically encoded polypeptide chain. Thus, in another preferred embodiment, synthetic peptides and proteins employed in the methods of the invention have a water-soluble polymeric protecting group attached to an irregular amino acid of a polypeptide chain thereof. More preferred irregular amino acids for attachment of a water-soluble polymeric protecting group thereto employ chemoselective ligation chemistry that can be used in the presence of genetically encoded functional groups without reacting with them, such as those described herein.

In a preferred embodiment, the invention is directed to such synthetic peptides and proteins having one or more water-soluble polymeric protecting groups attached thereto. Preferred synthetic peptides and proteins have a water-soluble polymeric protecting group attached at a site that includes, but is not limited to one or more of the following sites selected from the group consisting of: N-terminus, C-terminus, and an internal residues exposed on the surface of the folded protein. In particular, positions of modification for the synthetic peptides and proteins of the invention include residues located in a disordered loop, region or domain of the protein, immunogenic sites, and/or at or near sites of potential protease cleavage.

The most preferred synthetic peptide and proteins employed in the invention have one or more water-soluble polymeric protecting groups attached to at least one site corresponding to a glycosylation site of a ribosomally specified peptide or protein. Accordingly, in a preferred embodiment, the ribosomally specified peptide or protein comprises one or more glycosylation sites, and a water-soluble polymeric protecting group is attached to the polypeptide chain at one or more sites corresponding to one or more the glycosylation sites of the ribosomally specified peptide or protein. In a preferred embodiment, the water-soluble polymeric protecting group is attached to the polypeptide chain exclusively at one or more sites corresponding to one or more such glycosylation sites. These aspects of the invention include synthetic peptides and proteins where the ribosomally specified peptide or protein is recombinantly produced. Accordingly, the ribosomally specified peptide or protein can be a natural or a non-natural peptide or protein, the latter of which can further include one or more non-natural glycosylation sites.

By “glycosylation site” is intended an amino acid sequence of a protein that encodes for the enzymatic attachment of an oligosaccharide (carbohydrate) chain to the side-chain of an amino acid residue of the amino acid sequence of the protein; exemplified by N-linked and O-linked glycosylation sites. It will be appreciated that proteins that have been mutated to eliminate one or more of such glycosylation sites are embodied in the definition of “glycosylation site”, as the residual site for polymer modification will be positionally the same. By “naturally occurring glycosylation site” is intended a glycosylation site of a glycoprotein found in nature. By “non-naturally occurring glycosylation site” is intended a glycosylation site that has been engineered into a protein.

In another embodiment, synthetic peptides or proteins are modified with a water-soluble polymeric protecting group that is attached to a side-chain of an amino acid at a ligation site of the peptide or protein. These compounds are synthesized by forming a ligation product having an unprotected side-chain functional group at the ligation site by ligating a first peptide or polypeptide segment having an N-terminal amino acid comprising a chemoselective reactive functional group, such as a cysteine, to a second peptide or polypeptide having a ligation compatible C-terminal functional group, such as a α-carboxy thioester, and attaching a water-soluble polymeric protecting group to the unprotected side-chain thiol functional group at the ligation site, for example, through a displaceable or reducible (i.e., cleavable) disulfide or mixed disulfide bond.

Utilization of the chemical ligation site modification methods of the invention afford several advantages over the prior art, including the robust synthesis of a diverse range of peptides and proteins that are otherwise devoid of suitable ligation sites, expansion of the sites (and attachment chemistries) to which site-specific modification can be exploited in a routine and cost-effective manner, as well as the synthesis of synthetic peptides and proteins that are water soluble, and optionally of substantial molecular weight, among others. They also are particularly suited for high throughput analoging for fine-tuning of desired biological properties, including scanning individual or multiple sites for water-soluble polymeric protecting group attachment.

In another preferred embodiment, the invention may employ a synthetic peptide or protein comprising a polypeptide chain comprising an amino acid sequence of a ribosomally specified peptide or protein, where the polypeptide chain has one or more water-soluble polymeric protecting groups attached thereto, wherein the water-soluble protecting group has a molecular weight of greater than 500 kDa. The molecular weight can be controlled by increasing or decreasing the number and structure of the water-soluble polymer utilized for modification. For the purposes of the present invention, such determinations of molecular weight are to be made by theoretical mass calculations, including specific mass calculations for mono-disperse water-soluble protecting group polymers, as well as an average molecular weight range for heterodisperse water-soluble protecting group polymers. The term “monomer molecular weight” is intended to refer to the molecular weight of a monomer of a water-soluble protecting group polymer, as distinguished from polymers that may possess multiple copies of a given polymer. For example, exemplary preferred water-soluble polymeric protecting groups of the invention have a water-soluble polyamide repeat unit of the formula —[NH—(CH₂—(CH₂—CH₂—O)₃—CH₂—CH₂—CH₂)—NHC(O)—CH₂—CH₂—C(O)]ₙ— where when n=1 the polymer construct is designated 1PLP, or where n=2, 3, 4, 5 or 6 is designated 2PLP, 3PLP, 4PLP, 5PLP and 6PLP, respectively. Such PLPs have monomer molecular weights ranging from about 300 kDa to about 2000 kDa. However, much larger constructs are considered to be well within the scope of the present invention. Most preferably, such water-soluble polymeric protecting groups will have a discrete number atoms, as distinguished from an average number of atoms or molecular weight range.

As noted above, at least one of water-soluble polymeric protecting groups will be attached through a cleavable linker to the target compound of interest, such as a side chain of an amino acid sequence of a target peptide or polypeptide of interest. Production of a synthetic peptide or protein bearing water-soluble polymeric protecting groups can be envisioned as having the following steps: design, peptide synthesis, peptide ligation, (optionally, folding of the full-length ligation product to generate protein), and assessment of the peptide's or protein's desired characteristics. The incorporation of one or more non-genetically encoded amino acids occurs at the peptide synthesis and/or ligation stage. Modification with a water-soluble polymeric protecting group thus can be performed at one or more of the peptide synthesis, ligation or on the folded product steps.

In general, it is preferred to attach a water-soluble polymeric protecting group to the peptides prior to ligation, or to the ligation product prior to folding in the case where a protein is being made. Peptides and proteins produced in this manner that exhibit desired solubility and ligation characteristics are selected and represent synthetic peptides and proteins of the invention having one or more water-soluble polymeric protecting groups attached thereto. Such synthetic peptides and proteins having one or more water-soluble polymeric protecting groups attached thereto are then modified by the removal of one or more water-soluble protecting group polymers, and attachment of a desired chemical adduct in their place.

In a preferred method, a peptide or polypeptide chain comprising a synthetic peptide or protein is made by chemically ligating peptide segments comprising non-overlapping amino acid sequences of a polypeptide chain of the synthetic target. In particular, synthetic peptide or protein molecules of the invention can be made by chemically ligating peptide segments comprising non-overlapping amino acid sequences of a polypeptide chain of the synthetic peptide or protein molecule of interest, where one or more of the peptide segments used for ligation has a one or more water-soluble polymeric protecting groups attached thereto at a user-defined and pre-selected site. The polymer-modified polypeptide chain bearing one or more water-soluble polymeric protecting groups may then be multiplexed by replacing one or more of the water-soluble polymeric protecting groups with a chemical adduct of interest, or optionally folded and then multiplexed to produce a library of desired chemical adduct-modified synthetic constructs.

Another preferred method for producing the synthetic peptides and proteins of the invention comprises chemically ligating peptide segments comprising non-overlapping amino acid sequences of a polypeptide chain of a synthetic polymer protecting group-modified peptide or protein of the invention, and replacing one or more of the water-soluble protecting group polymers with a chemical adduct, and/or attaching a water-soluble protecting group polymer to a side-chain of an amino acid at one or more chemical ligation sites thereof. The polymer protecting group-modified polypeptide chain may then be manipulated as described above.

In another embodiment, although generally less preferred, synthetic peptides and proteins can be made by (1) chemically ligating peptide segments comprising non-overlapping amino acid sequences of a polypeptide chain of a synthetic peptide or protein to form a full-length polypeptide chain corresponding to the synthetic peptide or protein of interest, where at least one peptide segment comprises an irregular amino acid having a first chemoselective functional group, (2) folding the polypeptide chain, (3) attaching a water-soluble protecting group polymer thereto that comprises a second chemoselective group that is uniquely and mutually reactive with the first chemoselective group, and (4) replacing the water-soluble protecting group polymer with a chemical adduct.

Ligation schemes useful in the production of synthetic peptides and proteins of the present invention, as well as methods and materials for carrying out same, are described in WO 02/19963 and WO 02/20033.

In conjunction with the design, the peptides or polypeptide segments utilized for synthesizing the polypeptide backbone are constructed. Methods useful in the synthesis of peptides and polypeptides backbones are described in, for example, PCT Publication Nos. WO 02/20557 (extended native chemical ligation); WO 02/20034 (pseudo-native chemical ligation); WO 98/56807 (solid phase native chemical ligation); and in U.S. Pat. No. 6,307,018 (native chemical ligation); U.S. Pat. No. 6,217,873 (polyoxime compounds); U.S. Pat. No. 6,174,530 (homogenous polyoxime compositions); and U.S. Pat. No. 6,001,364 (hetero-polyoxime compounds).

In general, synthesis of a peptide or polypeptide backbone by chemical ligation involves selection of suitable ligation sites that are chosen based on the ligation chemistry selected for assembling the various polypeptide backbone segments, the reversible (or cleavable) polymer attachment chemistry chosen for a given target peptide or protein, and the particular polymer attachment sites. When native chemical ligation is employed, cysteine ligation sites are determined by scanning the target polypeptide backbone amino acid sequence for suitable naturally occurring cysteine residue. When “Extended Native Chemical Ligation” is employed, ligation sites can be selected by scanning the target polypeptide backbone amino acid sequence for suitable naturally occurring ligation site junctions that permit robust ligations. Because extended native chemical ligation is not limited to ligation at cysteine residues, any number of residues may serve as the ligation site junction. In some instances, a combination of native and extended native chemical ligation may be part of the design.

In a preferred embodiment, native chemical ligation is used to generate part or all of the full-length polypeptide chain. Cysteines present in the naturally occurring protein on which the synthetic neutropoiesis stimulating protein is based can be used as the chemical ligation sites. However, where a preferred ligation junction is devoid of a suitable cysteine, the non-cysteine amino acid at that position can be replaced with a cysteine so as to permit native chemical ligation at that site. If desired, the newly introduced cysteine can be converted to a pseudo amino acid residue corresponding to the original amino acid at that position, as described herein. For instance, pseudo amino acids formed by conversion of cysteines at native chemical ligation sites is referred to herein as “Pseudo Native Chemical Ligation” and is described in detailed in WO 02/20034.

Alternatively, when the cysteine is introduced at a site for polymer protecting group modification, the side chain thiol can be exploited for the attachment of a thiol-reactive water-soluble polymer construct, provided that all other cysteines in the target polypeptide that one does not wish to modify are protected.

In another preferred embodiment, extended native chemical ligation can be utilized to generate part or all of the full-length polypeptide. For this method, N-terminal Nα-substituted 2 or 3 carbon chain alkyl or aryl thiol amino acids may be employed. Such residues (where present at the N-terminus of a peptide or polypeptide segment used for ligation) can be advantageously used to ligate that polypeptide to a polypeptide having a C-terminal α-carboxy thioester moiety, in accordance with the methods of extended native chemical ligation described herein.

Typically, the synthesis of peptides employs stepwise standard Boc and/or Fmoc solid phase peptide synthesis using standard automated peptide synthesizers, or manually following standard protocols, or ordered and purchased from commercial vendors. (“Synthetic Peptides, A User's Guide,” G. A. Grant, Ed., W. H. Freeman & Company, New York, N.Y., 1992; “Priciples of Peptide Synthesis, 2nd ed.,” M. Bodanszky, Ed., Springer-Verlag, 1993; “The Practice of Peptide Synthesis, 2nd ed.,” M. Bodanszky and A. Bodanszky, Eds., Springer-Verlag, 1994; and “Protecting Groups,” P. J. Kocienski, Ed., Georg Thieme Verlag, Stuttgart, Germany, 1994; “Fmoc Solid Phase Peptide Synthesis, A Practical Approach, Eds. W. C. Chan and P. D. White, Oxford University Press, 2000). For peptides utilized for thioester-mediated ligation, such as for native chemical ligation, they can be made following standard protocols as well. (see, e.g., Dawson et al., Science (1994) 266:776-779; Canne et al. Tetrahedron Lett. (1995) 36:1217-1220; Kent, et al., WO 96/34878; Kent, et al., WO 98/28434; Ingenito et al., JACS (1999) 121(49):11369-11374; and Hackeng et al., Proc. Natl. Acad. Sci. U.S.A. (1999) 96:10068-10073); Amiato et al., supra.).

For ligation and site-specific attachment of water-soluble polymeric protecting groups, chemically orthogonal strategies are generally employed in the synthesis of the peptides so as to avoid side reactions that result in unwanted attachment. For instance, depending on ligation design and the polymer protecting group attachment approach, a variety of orthogonal synthesis strategies can be exploited. In particular, the nature of the water-soluble polymeric protecting group to be attached, and in particular the functional group for joining it to the polypeptide are considered, for instance as discussed for the preferred water-soluble polymeric protecting groups of the invention.

In particular, the water-soluble polymeric protecting group is made to comprise a unique functional group U that is selectively reactive with a unique functional group n on a target peptide employed for ligation, full-length material or even the folded polypeptide. As chemical synthesis is employed, the peptide is made to contain a mutually reactive chemoselective group at a precise, user-defined site. This aspect of the invention embodies the principles of peptide synthesis (protecting group strategies) and chemical ligation (partial or no protecting group strategies). For the protecting group strategy, all potentially reactive functional groups except for the desired functional group on the water-soluble polymeric protecting group and its mutually reactive functional group present on the target molecule are blocked with other protecting groups. Many protecting groups are known and suitable for this purpose (See, e.g., “Protecting Groups in Organic Synthesis”, 3rd Edition, T. W. Greene and P. G. M. Wuts, Eds., John Wiley & Sons, Inc., 1999; NovaBiochem Catalog 2000; “Synthetic Peptides, A User's Guide,” G. A. Grant, Ed., W. H. Freeman & Company, New York, N.Y., 1992; “Advanced Chemtech Handbook of Combinatorial & Solid Phase Organic Chemistry,” W. D. Bennet, J. W. Christensen, L. K. Hamaker, M. L. Peterson, M. R. Rhodes, and H. H. Saneii, Eds., Advanced Chemtech, 1998; “Principles of Peptide Synthesis, 2nd ed.,” M. Bodanszky, Ed., Springer-Verlag, 1993; “The Practice of Peptide Synthesis, 2nd ed.,” M. Bodanszky and A. Bodanszky, Eds., Springer-Verlag, 1994; and “Protecting Groups,” P. J. Kocienski, Ed., Georg Thieme Verlag, Stuttgart, Germany, 1994). The water-soluble polymeric protecting groups and other protecting groups utilized for this purpose are typically removable under different conditions, i.e., they are orthogonal.

Thus, the water-soluble polymeric protecting groups can represent be made to posses a wide range of functional groups, such as those described above. For the partial or no protecting group strategy, the functional group U on the water-soluble polymeric protecting group and its mutually reactive functional group n present on the target peptide or polypeptide employ a chemoselective reaction pair in which other functional groups may be present in the reaction system but are unreactive. This includes groups amenable to amine capture strategies (e.g., ligation by hemiaminal formation, by imine formation, and by Michael addition), thiol capture strategies (e.g., ligation by mercaptide formation, by disulfide exchange), native chemical ligation strategies (e.g., ligation by thioester exchange involving cysteine or thiol contain side-chain amino acid derivative), and orthogonal ligation coupling strategies (e.g., ligation by thiazolidine formation, by thioester exchange, by thioester formation, by disulfide exchange, and by amide formation)(See, e.g., Coltart, D M., Tetrahedron (2000) 56:3449-3491).

As noted above, a preferred chemoselective U group for this embodiment will comprise a residue of a unique functional group employed in an aqueous compatible ligation chemistry such as native chemical ligation (Dawson, et al., Science (1994) 266:776-779; Kent, et al., WO 96/34878), extended general chemical ligation (Kent, et al., WO 98/28434), oxime-forming chemical ligation (Rose, et al., J. Amer. Chem. Soc. (1994) 116:30-33), thioester forming ligation (Schnölzer, et al., Science (1992) 256:221-225), thioether forming ligation (Englebretsen, et al., Tet. Letts. (1995) 36(48):8871-8874), hydrazone forming ligation (Gaertner, et al., Bioconj. Chem. (1994) 5(4):333-338), and thiazolidine forming ligation and oxazolidine forming ligation (Zhang, et al., Proc. Natl. Acad. Sci. (1998) 95(16):9184-9189; Tam, et al., WO 95/00846) or by other methods (Yan, L. Z. and Dawson, P. E., “Synthesis of Peptides and Proteins without Cysteine Residues by Native Chemical Ligation Combined with Desulfurization,” J. Am. Chem. Soc. 2001, 123, 526-533, herein incorporated by reference; Gieselnan et al., Org. Left. 2001 3(9):1331-1334; Saxon, E. et al., “Traceless” Staudinger Ligation for the Chemoselective Synthesis of Amide Bonds. Org. Left. 2000, 2, 2141-2143).

Given the various attachment chemistries described above, the bond formed between the water-soluble polymeric protecting group and a target peptide or polypeptide can comprise a residue of a bond selected from carbonate, ester, urethane, orthoester, amide, amine, oxime, imide, urea, thiourea, thioether, thiourethane, thioester, ether, thaizolidine, hydrazone, oxazolidine and the like. The most preferred bonds are hydrazone and oxime bonds that are removable by a suitable displacement reaction, e.g., hydrzide for displacing a hydrazone bond, or aldehyde, ketone, aminooxy for displacing the oxime bond. Disulfide or mixed disulfide type bonds can also be employed, where they are displaceable using thiols, mercaptans and the like. Where the bond formed between the water-soluble polymeric protecting group and the peptide or polypeptide of interest is not displaceable, then a cleavable linker can be employed that is provided by the target peptide or polypeptide (e.g., on a side chain of an irregular amino acid) or the water-soluble polymeric protecting group itself. In this embodiment, the cleavable linker will typically be one that can be cleaved under conditions that maintain the integrity of the peptide or polypeptide.

For instance, weak base or acid cleavable linkers typically employed in peptide synthesis are suitable for this purpose. Such linkers usable with the invention include, for example, PAL(5-(4′-aminomethyl-3′,5′-dimethoxyphenoxy)valeric acid, XAL(5-(9-aminoxanthen-2-oxy)valeric acid), 4-(alpha-aminobenzyl)phenoxyacetic acid, 4-(alpha-amino-4′-methoxybenzyl)phenoxybutyric acid, p-alkoxybenzyl (PAB) linkers, photolabile o-nitrobenzyl ester linkers, 4-(alpha-amino-4′-methoxybenzyl)-2-methylphenoxyacetic acid, 2-hydroxyethylsulfonylacetic acid, 2-(4-carboxyphenylsulfonyl)ethanol, (5-(4′-aminomethyl-3′,5′-dimethoxyphenoxy)valeric acid) linkers, WANG hydroxymethyl phenoxy-based linkers, RINK trialkoxybenzydrol and trialkoxybenzhydramine linkers, and Sieber aminoxanthenyl linkers. PAM, SCAL, and other linker systems may also be used. These linker systems are cleavable under well known acidolysis conditions (typically trifluoroacetic acid (TFA) or hydrogen fluoride (HF)), UV photolysis (λ≈350 nm) conditions, or catalytic hydrogenation conditions.

The peptide ligation step may employ solid or solution phase ligation strategies, particularly those as exemplified in PCT Publication Nos. WO 02/19963 and WO 02/20033. For example, precision attachment of a water-soluble polymeric protecting group to a peptide segment employable for ligation and production of synthetic peptides and proteins bearing such group or groups can be accomplished by first employing solid phase peptide synthesis (“SPPS”) (e.g., Fmoc or Boc SPPS), in which an amino acid side chain targeted for polymer attachment is protected with an orthogonal protecting group (e.g., if using Fmoc SPPS, a Boc group can be used to protect the site of polymer attachment, or if using Boc SPPS, an Fmoc group can be employed as the orthogonal protecting group). Following peptide synthesis, the orthogonal protecting group is selectively removed while the rest of the peptide remains protected. This affords a single attachment site for the next step—solid phase polymer synthesis. Once the orthogonal protecting group is removed, the water-soluble polymeric protecting group or a precursor thereof can be readily attached.

As noted above, chemical ligation involves the formation of a selective covalent linkage between a first chemical component and a second chemical component. Unique, mutually reactive, functional groups present on the first and second components can be used to render the ligation reaction chemoselective. For example, the chemical ligation of peptides and polypeptides involves the chemoselective reaction of peptide or polypeptide segments bearing compatible unique, mutually reactive, C-terminal and N-terminal amino acid residues. Several different chemistries have been utilized for this purpose, examples of which include native chemical ligation (Dawson, et al., Science (1994) 266:776-779; Kent, et al., WO 96/34878; Kent, et al., WO 98/28434), oxime forming chemical ligation (Rose, et al., J. Amer. Chem. Soc. (1994) 116:30-34), thioester forming ligation (Schnölzer, et al., Science (1992) 256:221-225), thioether forming ligation (Englebretsen, et al., Tet. Letts. (1995) 36(48):8871-8874), hydrazone forming ligation (Gaertner, et al., Bioconj. Chem. (1994) 5(4):333-338), and thiazolidine forming ligation and oxazolidine forming ligation (Zhang, et al., Proc. Natl. Acad. Sci. (1998) 95(16):9184-9189; Tam, et al., WO 95/00846; U.S. Pat. No. 5,589,356); Gieselman et al., Selenocysteine-mediated native chemical ligation (Org. Lett. (2001) 3(9):1331-1334); and Staudinger amide forming chemical ligation (Saxon et al., Org. Lett. (2000) 2:2141-2143). Thus, as will be appreciated, any chemoselective reaction chemistry that can be applied to the ligation of unprotected peptide segments and amenable for such purpose.

Reaction conditions for a given ligation chemistry are selected to maintain the desired interaction of the peptide or polypeptide segments employed for ligation. For example, pH and temperature, water-solubility of the ligation components, ratio of the first segment to the second segment, water content and composition of the reaction mixture can be varied to optimize ligation. Addition or exclusion of reagents that solubilize the ligation segments to different extents may further be used to control the specificity and rate of the desired ligation reaction, i.e., control exposure and presentation of reactive groups by manipulating solubility of the peptide or polypeptide segments. Reaction conditions are readily determined by assaying for the desired chemoselective reaction product compared to one or more internal and/or external controls.

Where the ligation involves the joining of a polypeptide that possesses an N-terminal cysteine residue, the procedure of native chemical ligation is preferably employed (Dawson, et al., Science (1994) 266:776-779; Kent, et al., WO 96/34878; Kent, et al., WO 98/28434)). This methodology has proven a robust methodology for generating a native amide bond at the ligation site. Native chemical ligation involves a chemoselective reaction between a first peptide or polypeptide segment having a C-terminal α-carboxythioester moiety and a second peptide or polypeptide having an N-terminal cysteine residue. A thiol exchange reaction yields an initial thioester-linked intermediate, which spontaneously rearranges to give a native amide bond at the ligation site while regenerating the cysteine side chain thiol. In many instances, the sequence of the natural protein will comprise suitably placed cysteine residues such that polypeptide fragments having an N-terminal cysteine residue may be synthesized and used in a native chemical ligation reaction. In other instances, the peptide synthesis can be conducted so as to introduce cysteine residues into a polypeptide for this purpose. Thus in its standard form, native chemical ligation involves thioester-mediated chemoselective reaction at a cysteine residue in a target polypeptide sequence; a peptide bond is formed at the ligation site and the side chain of the Cys is regenerated in native form.

Alternatively, the peptides and proteins of the invention may be synthesized through the use of “Pseudo-Native Chemical Ligation,” or “Extended Native Chemical Ligation, which are described in PCT Publication Nos. WO 02/20557 (extended native chemical ligation); WO 02/20034 (pseudo-native chemical ligation). Pseudo-Native Chemical Ligation involves the use of non-naturally occurring pseudo-amino acid residues at preselected positions in the peptides employed in the protein synthesis. The structures of such pseudo-amino acids mimic both the structures of cysteine and the structures of the amino acids that are naturally found at such preselected positions in the protein being synthesized. Pseudo-native chemical ligation is thus directed to the thioalkylation of cysteine side chains generated at ligation sites from native chemical ligation. A preferred aspect is thioalkylation of cysteine ligation sites wherein at least one peptide contains a native cysteine having its thiol side chain protected with a suitable protecting group.

In one embodiment of the invention, the thiol moiety of a cysteine group is modified into a desired side chain, for example, into the side chain of a ribosomally specified amino acid, an analog of such an amino acid, or into a non-ribosomally specified amino acid. As used herein, a ribosomally specified amino acid is an amino acid that is recognized by ribosomes in the process of protein translation and can be incorporated into a ribosomally produced protein. Considerable published literature exists describing chemical modifications of the cysteine side chain thiol moiety (see, e.g., “Current Protocols in Protein Science,” Edited by: John E. Coligan et al., John Wiley & Sons, NY (2000)). Kaiser, E. T. has described the conversion of cysteine residue side chains to mimic the chemical properties of a naturally occurring amino acid side chain (see, e.g., Kaiser, E. T. et al., “Chemical Mutation Of Enzyme Active Sites,” Science. Nov. 2, 1984; 226(4674):505-11). Additionally, the use of a cysteine side chain to introduce a label into a peptide or protein has been described. Cysteine side chain modifications are reviewed in Chemistry of Protein Conjugation and Crosslinking, S. S. Wong, (1991, CRC Press); Chemical Modification of Proteins, Gary E. Means et al., (1971, Holden-Day), Chemical Modification of Proteins: Selected methods and analytical procedures, Glazer, A. N. et al. (1975, Elsevier); Chemical Reagents for Protein Modification, R L Lundblad (1991, CRC Press). Tam et al. (Biopolymers (1998)46:319-327) have disclosed the use of homocysteine (—CH₂—CH₂—SH) for non-cys native chemical ligation, followed by thioalkylation using methyl p-nitrobenzenesulfonate (methylating reagent) to convert the homocysteine side chain to a native methionine side chain (—CH₂—CH₂—S—CH₃).

The methods described herein can also be applied for conversion of homocysteines to pseudo amino acids as well. However, as with the conversion of cysteines described herein, in accordance with the present invention it is necessary to use protecting groups to avoid destruction of native cysteines involved in disulfide pairing for peptides that contain at least one native cysteine that one does not wish to convert. Suitable protecting groups are described below.

While the method of pseudo-native chemical ligation does not facilitate the mimicking of the side chains of certain ribosomally-specified amino acids (e.g., the side chains of glycine, alanine, valine, and proline) (alanine's side chain can, however, be formed through a desulfurization reaction (Liang, Z. Y. and Dawson, P. E., “Synthesis of Peptides and Proteins without Cysteine Residues by Native Chemical Ligation Combined with Desulfurization,” J. Am. Chem. Soc. 2001, 123, 526-533, herein incorporated by reference), it may be used to form side chains that mimic many ribosomally-specified or non-encoded amino acids. Amino acids produced in accordance with the pseudo-native chemical ligation method of the present invention will contain a thioether linkage, and will have no beta-branching (in that they will all include a methyl group at the beta position, i.e., aa-CH₂—S—. Thus, the pseudo-amino acid versions of the beta-branched amino acids, isoleucine and threonine can be made to have the pendant side chain structure, without having the beta geometry and its attendant constraints.

Significantly, the methods described herein may be used to form amino acid side chains that are the same length as that of ribosomally specified amino acids, or are longer or shorter than such length. Such alteration in side chain length can be used to stabilize (or destabilize) the three-dimensional conformation to increase protein stability (or to enhance the ability of the protein to alter its conformation and thereby accept a different range of substrates, inhibitors, receptors, ligands, etc. relative to those accepted by the naturally occurring protein. For example, Cys-CH₂—SH+Br—CH₂—COOH yields Cys-CH₂—S—CH₂—COOH (such “pseudo-glutamic acid” has one additional side chain atom, namely the —S— group; alternatively, if used in the place of aspartic acid, it will possess two additional-side chain atoms, namely a —CH₂—S— group). Other side chains have the same number of atoms in the side chain, but differ by inclusion of the thioether linkage (—S—). For example, Cys-CH₂—SH+Br —CH₂—CH₂—NH-PG, followed by removal of PG yields Cys-CH₂—S—CH₂—CH₂—NH₂. The resulting structure has no additional atoms in the side chain, but one —CH₂— group is replaced with —S—. Methionine is another example here, Cys-CH₂—SH+I—CH₂—CH₃ yields Cys-CH₂—S—CH₂—CH₃ (versus native met structure of Met-CH₂—CH₂—S—CH₃); thus the thioether is relocated. Arginine also: Cys-CH₂—SH+Br—CH₂—NH—CH((—NH₂)(═NH₂⁺)) yields Cys-CH₂—S—CH₂—NH—CH((—NH₂)(═NH₂⁺)), which also may be generated in protected form where the guanidyl group is protected to reduced the potential for side reactions. Preferably, protection of reactive amino groups, particularly for the constructing pseudo lysine can be employed to avoid unwanted side reactions. Once the thioalkylation reaction is performed, the protecting group can be removed.

However, where it is either inconvenient or undesirable to modify a protein sequence so as to introduce a cysteine or homocysteine residue at a given N-terminus of a polypeptide utilized for ligation, or utilize a pseudo amino acid at the ligation site, the method of native chemical ligation may be extended using polypeptides whose N-terminus has been modified to contain an N-substituted, and preferably, Nα-substituted, 2 or 3 carbon chain amino alkyl or aryl thiol, and thereby permit the principles of native chemical ligation to be employed with polypeptides lacking cysteine residues (see, WO 02/19963 and WO 02/20033).

The method of “Extended Native Chemical Ligation” involves ligating a first component comprising a carboxyl thioester, and more preferably, an α-carboxyl thioester with a second component comprising an acid stable N-substituted, and preferably, Nα-substituted, 2 or 3 carbon chain amino alkyl or aryl thiol. Chemoselective reaction between the carboxythioester of the first component and the thiol of the N-substituted 2 or 3 carbon chain alkyl or aryl thiol of the second component proceeds through a thioester-linked intermediate, and resolves into an initial ligation product. Extended Native Chemical Ligation is described in detail in PCT Publication Nos. WO 02/19963, WO 02/20033, and WO 02/20557.

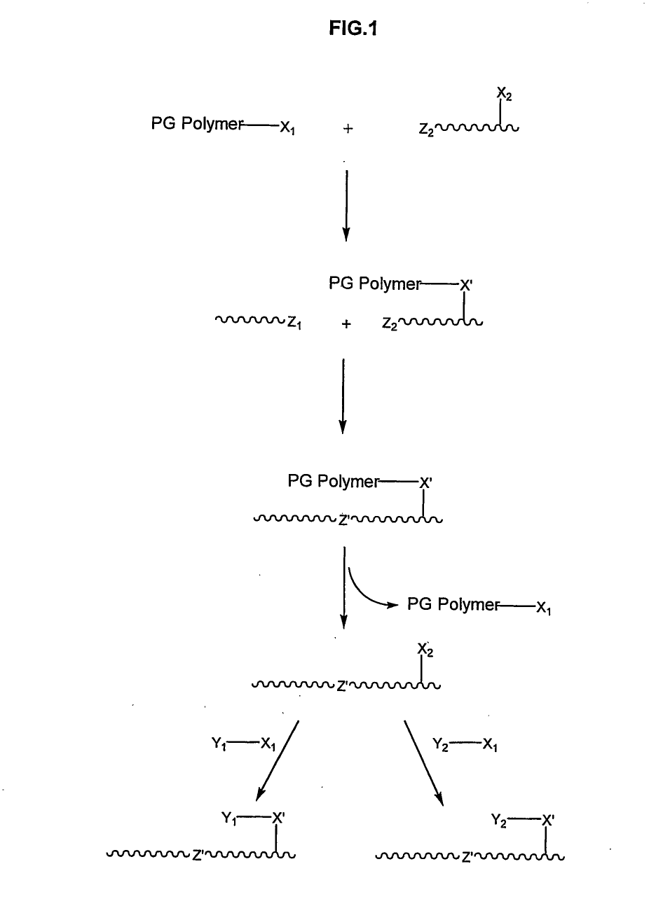

The above described methods and compositions of the invention are exemplified by the total chemical synthesis of a library of synthetic polymer-modified peptides, polypeptides and proteins. FIG. 1 illustrates this approach for the attachment of a single water-soluble polymeric protecting group to a first peptide, where the first peptide bears a unique reactive functional group X² that is capable of forming a reversible bond X′ with an incoming water-soluble polymeric protecting group PG Polymer-X₁ bearing a mutually reactive functional group X₁. The first peptide also bears a second unique functional group Z₂ that is unreactive with X₁ or X₂. Following attachment of the water-soluble polymeric protecting group, the polymer-modified peptide is then reacted with a second peptide bearing a reactive functional group Z₁ that is mutually reactive in a chemical ligation reaction with Z₂, to form a ligation product having ligation site Z′ bearing the water-soluble polymeric protecting group at X′. This water-soluble polymeric protecting group is then removed from the ligation product, split into two separate reaction systems, and then reacted with two different chemical adducts Y₁—X₁ and Y₂—X₁ of interest that each bear the same functional group X₁ to form two different chemically modified ligated polypeptide chains.

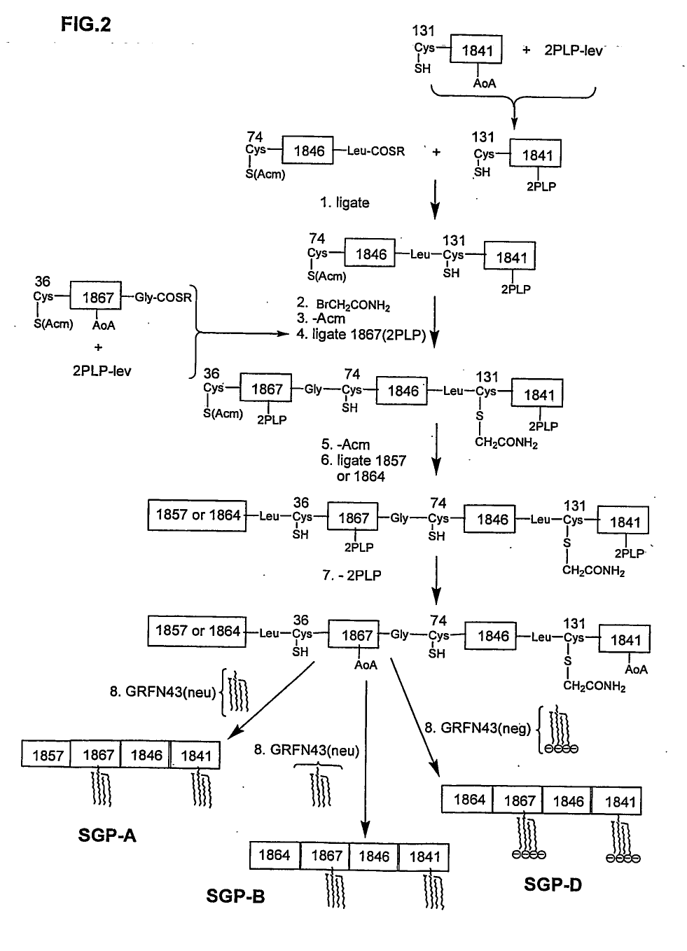

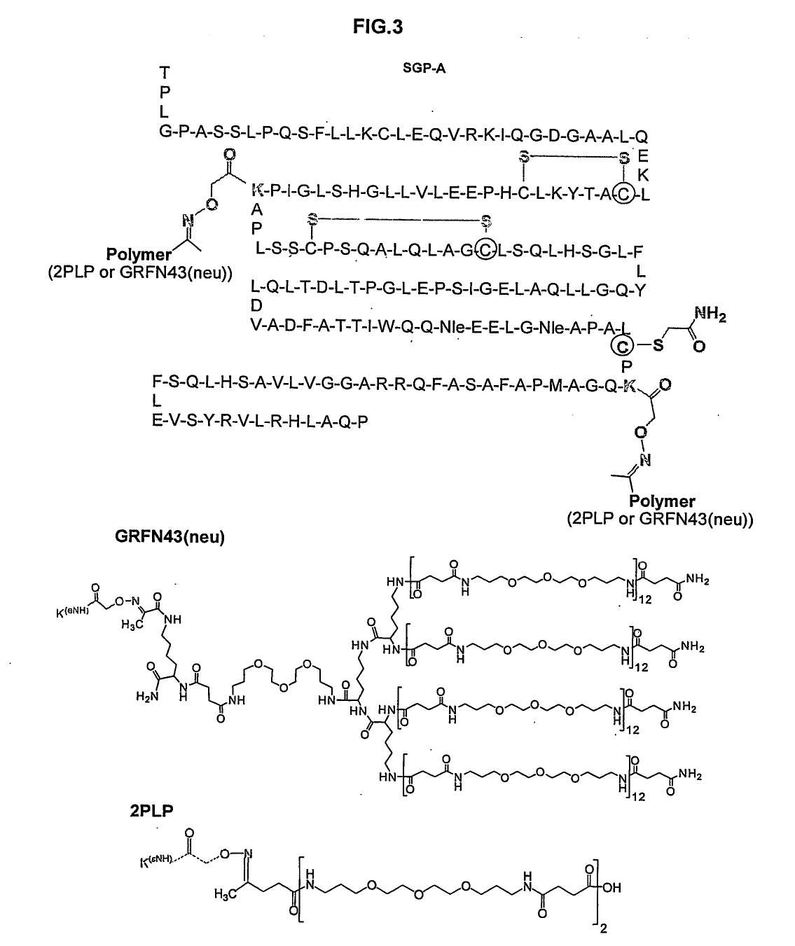

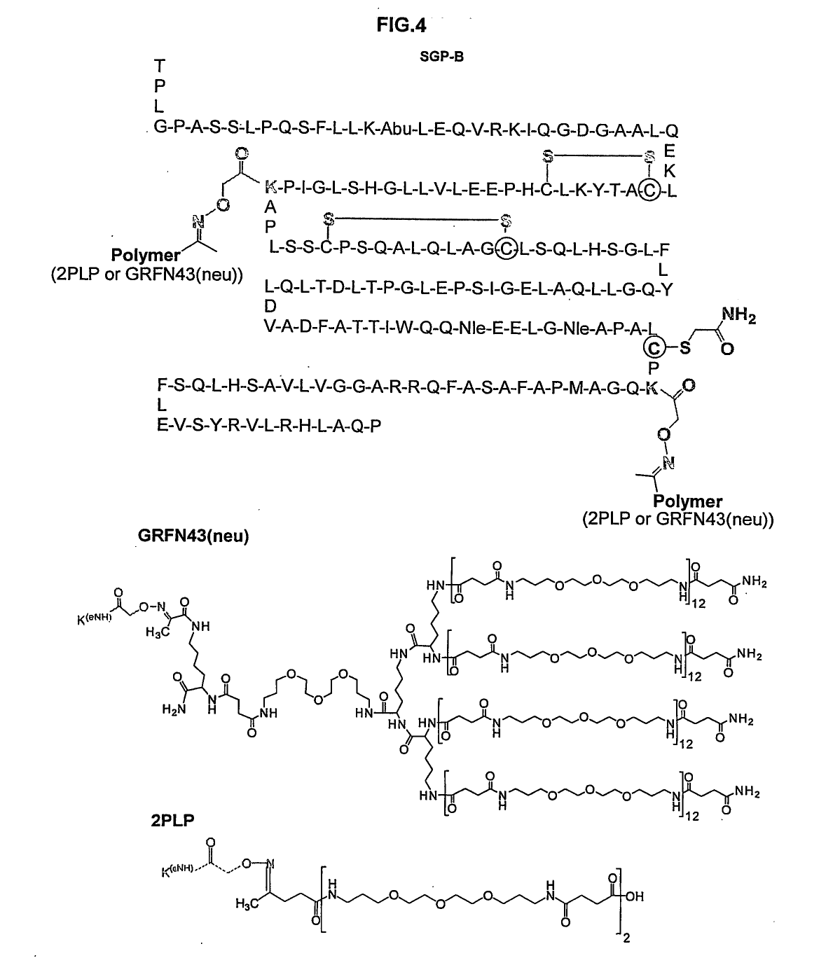

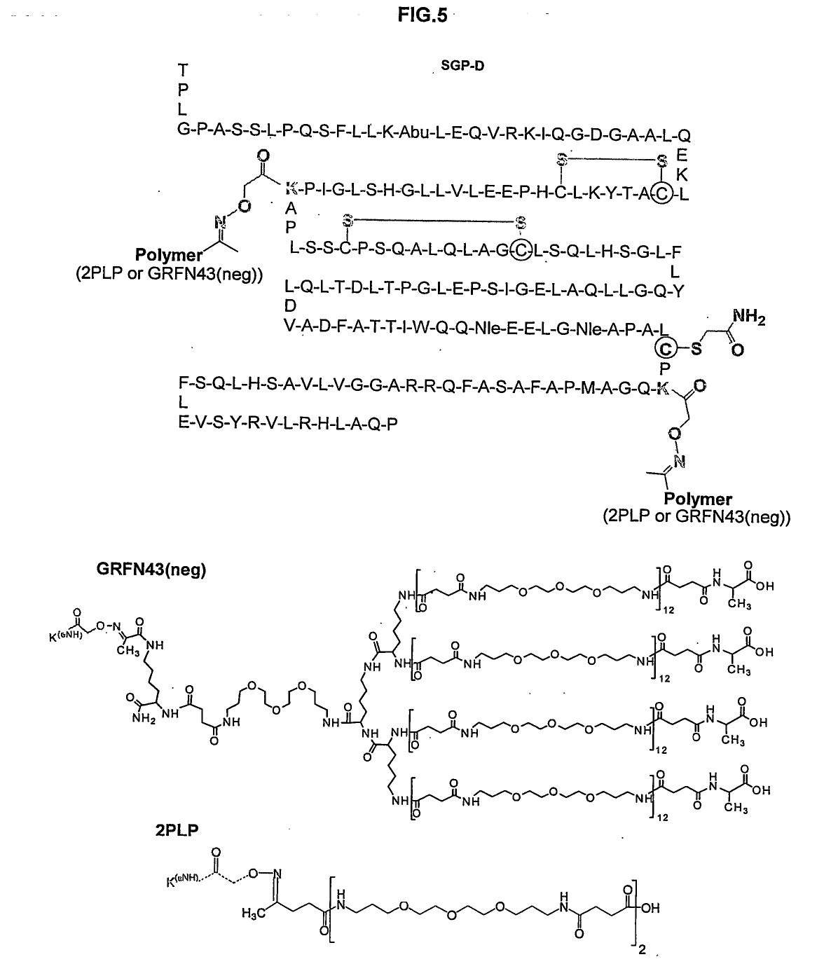

Specific synthetic schemes for exemplary water-soluble polymeric protecting groups, synthetic peptides and proteins of the invention are provided in the Examples below, and in FIGS. 2, 3, 4 and 5. For instance, a schematic illustrating the chemical synthesis of SGP-A, SGP-B and SGP-D using a multiplex polymer ligation approach as described below is shown in FIG. 2. Briefly, in FIG. 2, a “multiplex polymer ligation” method is illustrated for constructing full-length intermediate polypeptides bearing water-soluble polymeric protecting groups at positions selected for the subsequent site-specific attachment of different permanent water-soluble polymers in a split-synthesis strategy. In particular, FIG. 2 shows an approach where a removable water-soluble polymer-based protecting group (2PLP) bearing a levulinyl ketone moiety is attached in a site-specific and exclusive manner through an oxime bond-forming chemical ligation reaction to lysylaminooxy groups incorporated at position 58 on peptide segment 1867, and at position 133 on peptide segment 1841. These two precursor peptides were utilized to assemble two different full-length intermediate polypeptides bearing the 2PLP groups at positions 58 and 133 that permitted subsequent site-specific attachment of different water-soluble polymers at these positions in a split-synthesis stratagem. As shown, peptide 1841 (2PLP) bears an N-terminal cysteine at position 131, which is utilized to react with the leucine thioester at position 130 of peptide 1846 (also bearing an N-terminal Acm-protected cysteine at position 74) in a native chemical ligation reaction to form a native amide bond at cysteine ligation site position 131. The resulting ligation product, 1846+1841(2PLP) is then carboxyamidomethylated to convert the sole free side chain thiol of cysteine residue 131 to form a pseudoglutamine at that site. Following Acm removal, 1846+1841(2PLP) is ligated to 1867(2PLP), and then to either peptide 1857 or 1864 following standard native chemical ligation protocols. The 2PLP groups at positions 58 and 133 on the resulting two different full-length intermediate polypeptides (as shown in FIGS. 3, 4 and 5) are then removed and replaced with either a branched neutrally charged water-soluble polymer (e.g., GRFN43(neu)) or a branched negatively charged water-soluble polymer (e.g., GRFN43(neg)) at positions 58 and 133 through a permanent oxime-forming ligation reaction utilizing incoming polymers bearing a single unique pyruvyl ketone moiety (as shown in FIGS. 3, 4 and 5).

As shown in FIGS. 2, 3, 4 and 5, the full-length SGP-A, -B and -D products include two water-soluble polymers attached exclusively at user-defined sites, corresponding to position 58 and position 133. However, the constructs differ in several respects. In particular, two of the constructs bear neutral polymers (SGP-A and SGP-B), whereas one construct bears negatively charged polymers (SGP-D). Moreover, as shown the full-length SGP-A product differs in its polypeptide backbone from SGP-B and SGP D in peptide segments 1857 (SGP-A) and 1864 (SGP-B and SGP-D).

### ABBREVIATIONS

The following abbreviations may be used herein:
Abu=Aminobutyric acid
Acm=acetamidomethyl thiol-protecting group [i.e. —CH₂NHCOCH₃]
Aib=aminoisobutyric acid
AoA=aminooxyacetyl
Arg(Tos)=L-arginine(side chain N^{δ}toluenesulfonyl-protected)
ART=absolute reticulocyte count
Asp(cHex)=L-aspartic acid(side chain cyclohexyl ester-protected)
AUC=area under the curve
Boc=tert.butoxycarbonyl
Bom=benzyloxymethyl
CD circular dichroism
CDI carbonyldiimidiazole
CHO=chinese hamster ovary
CL=clearance (mL/hr/kg)
Cmax=maximum concentration
Cys(4MeBzl)=L-cysteine(side chain (4-methyl)benzyl-protected)
Cys(Acm)=L-cysteine(side chain acetamidomethyl [i.e. —CH₂NHCOCH₃]-protected)
DBU Diazabicycloundecane
DCM=dichloromethane
DIC=diisopropylcarbodiimide
DIEA=diisopropylethylamine
DMF=dimethylformamide
Dmg=dimethylglycine
DMSO=dimethylsulfoxide
Dnp=dinitrophenyl
DPC=dodecylphosphocholine
Dpr=L-1,2diaminopropionic acid
ED50=effective dose required to reach 50% maximum effect
EDA=(4,7,10)-trioxatridecane-1,13diamine (also called TTD)
ELISA=enzyme-linked immunoassay
ES-MS=electrospray ionization mass spectrometry
FBS=fetal bovine serum
Glu(cHex)=L-glutamic acid(side chain cyclohexyl ester-protected)
G-CSF=granulocyte colony stimulating factor
GM-CSF=granulocyte-macrophage colony stimulating factor
HATU=O-(7-azabenzotriazol-1-yl)-1,1,3,3-tetramethylammonium hexafluorophosphate
His(Dnp)=L-histidine(side chain N^{lm}dinitrophenyl-protected)
HOBT=N-hydroxybenzotriazole
HPLC=high pressure liquid chromatography
IMDM=Iscove's modified Dulbecco's medium
IPA=isopropanol
Lev=levulinic acid
Lys(CIZ)=L-lysine(side chain 2-chlorobenzyloxycarbonyl)-protected
MBHA=4-methylbenzhydrylamine
mcg=microgram
MRT=mean residence time
Mtt=4-methylTrityl
MTT=thiazolyl blue
NHS=N-hydroxysuccinimide
—OCH₂-Pam-resin=—O—CH₂-Bz-CH₂CONHCH₂ (copolystyrene-divinylbenzene)-resin
Pbo=4-(CH₃S(O)-)benzyl
PBS=phosphate buffered saline
RSA=rat serum albumin
SDS=sodium dodecyl sulfate
SDS-PAGE=SDS-polyacrylamide gel electrophoresis
SGP=synthetic granulocyte stimulating protein (used interchangeably with SNP)
SNP=synthetic neutropoiesis stimulating protein (used interchangeable with SGP)
Ser(Bzl)=L-serine(side chain benzyl-protected)
Succ=succinyl
TTD=(4,7,10)-trioxatridecane-1,13diamine (used interchangeable with EDA)

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

### Peptide Synthesis

Thioester peptides were synthesized on a thioester-generating resin by the in situ neutralization protocol for Boc (tert-butoxycarbonyl) chemistry and stepwise solid phase peptide synthesis (SPPS) using established SPPS, side-chain protection and thioester-resin strategies (Hackeng, et al., PNAS (1999) 96:10068-10073; and Schnolzer, et al., Int. J. Pept. Prot. Res., (1992) 40: 180-193)) on an ABI433A automated peptide synthesizer or by manual chain assembly, or ordered and acquired from commercial vendors. For instance, a standard set of Boc SPPS protecting groups was used, namely: Arg(Tos); Asp(cHex); Cys(4MeBzl) and Cys(Acm); Glu(cHex); His(Dnp); Lys(2-CIZ); Ser(Bzl); Thr(Bzl); Trp(formyl); Tyr(BrZ); Met, Asn, Gln were side-chain unprotected. Non-thioester peptides were synthesized analogously on a —OCH2-Pam-resin. The peptides were deprotected and simultaneously cleaved from the resin support using HF/p-cresol according to standard Boc chemistry procedure; however, for those peptides containing protecting groups not removed in HF/p-cresol, the protecting groups were retained. For instance, these include Acm-protected cysteines as well as Dnp-protected histidines and formyl protected tryptophans. For histidine, the Dnp is automatically removed during the native chemical ligation reaction in the presence of nucleophiles, such as thiophenol. The Acm and formyl group removal conditions are described below in detail. The peptides were purified by preparative C4 reverse-phase-high pressure liquid chromatography (HPLC). Fractions containing pure peptide were identified using ES-MS (electrospray ionization mass spectrometry), pooled and lyophilized for subsequent manipulation and/or ligation.

### Example 2

### Synthesis of 2PLP-Levulinyl Oxime Protection Group

On a 0.5 mM scale, 0.5 mmole (˜0.5 grams) Sasrin acid labile, carboxylic acid-generating polystyrene resin (hydroxyl substitution 1.02 mmole/g;) was swelled in DMF for 15 minutes and then drained. To this hydroxyl-functionalized resin was added 450 mg (4.5 mmole) succinic anhydride and 488 mg (4 mmole) 4-(dimethylamino)pyridine dissolved in 8 ml of DMF containing 500 microliter (3.9 mmole) DIEA (diisopropylethylamine) and allowed to react for 30 minutes, then drained. The coupling was repeated and excess reactants and soluble coproducts were removed by a 1 minute vortexing flow wash with DMF (˜50 ml), then drained. The HOOC—CH₂CH₂CO—O-resin (0.5 mmole) was activated by addition of 8 ml of fresh 1.0 M (8 mmole) CDI solution in DMF and allowed to react for 40 minutes, then drained. The resin was activated with 8 ml of fresh 1 M CDI (Carboxydiimidazole) solution in DMF and 4 mL (4,7,10)trioxatridecane-1,13diamine (TTD or also called EDA) was added in 4 mL 0.5M HOBT solution coupled for 30 minutes. After two cycles of this process, 581 mg Levulinic acid was activated 6.3 ml Diisopropyl carbodiamide in DCM (dichloromethane) for 5 minute and coupled to the resin for 10 minutes. The resin was cleaved using standard Fmoc procedures and the protecting group was purified by reversed-phase HPLC by a linear gradient. The structure of the 2PLP-levulinyl (“2PLP-lev”) protecting groups is as follows:

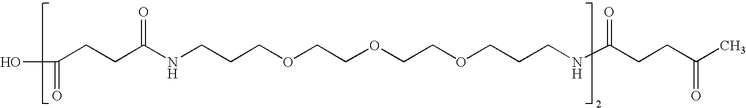

### Example 3

### Synthesis of Linear (Succ-TTD)₁₂-Succ-AlaOtBu (GRFNP39)

(Succ-TTD)₁₂-Succ-AlaOtBu (GRFNP39) was synthesized on a 0.5 mmol scale. The basic “Succ-TTD” repeat structure of GRFNP39 is shown below.

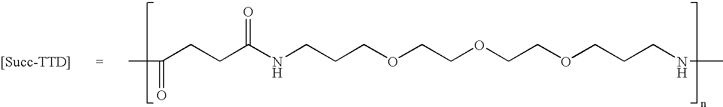

0.5 mmole (˜0.5 grams) Sasrin acid labile, carboxylic acid-generating polystyrene resin (hydroxyl substitution 1.02 mmole/g;) was swelled in DMF for 15 minutes and then drained. To this hydroxyl-functionalized resin was added 450 mg (4.5 mmole) succinic anhydride and 488 mg (4 mmole) 4-(dimethylamino)pyridine dissolved in 8 ml of DMF containing 500 microliter (3.9 mmole) DIEA (diisopropylethylamine) and allowed to react for 30 minutes with vortex agitation, then drained. The coupling was repeated and excess reactants and soluble coproducts were removed by a 1 minute vortexing flow wash with DMF (-50 ml), then drained. The HOOC—CH₂CH₂CO—O-resin (0.5 mmole) was activated by addition of 8 ml of fresh 1.0 M (8 mmole) CDI solution in DMF and allowed to react for 40 minutes, then drained. Excess reactants and soluble coproducts were removed by a 1 minute vortexing flow wash with DMF (˜50 ml), and drained. 4 ml (4 grams, 18.2 mmole) TTD dissolved in 4 ml 0.5M (2 mmole) HOBT solution in DMF was added and allowed to react with vortex agitation for 30 minutes and drained. Excess reactants and soluble coproducts were removed by a 1 minute vortexing flow wash with DMF (˜50 ml) and drained. Succinic anhydride (450 mg, 4.5 mmole) dissolved in 8 ml of 0.5M (4 mmole) HOBT (N-hydroxybenzotriazole) solution containing 500 microliter (3.9 mmole) DIEA was added to the resin and allowed to react with vortex agitation for 15 minutes, then drained. The three steps (CDI activation; TTD coupling; succinic anhydride reaction) were repeated eleven times [i.e. a total of twelve times]. Excess reactants and soluble coproducts were removed by a 1 minute vortexing flow wash with DMF (˜50 ml), and drained. The HOOC—CH₂CH₂CO(TTD-succinyl)₁₂-O-resin (0.5 mmole) was activated with 8 ml of fresh 1.0 M (8 mmole) CDI solution in DMF, allowed to react for 40 minute, and drained. Excess reactants and soluble coproducts were removed by a 1-minute vortexing flow wash with DMF (˜50 ml), and drained. 2.5 mmole H-AlaOtBu.HCl was dissolved in 4.75 ml 0.5 M (2.375 mmole) HOBT in DMF containing 150 microliter (111 mg, 0.825 mmole) DIEA, and allowed to react with the CDI-activated HOOC—CH₂CH₂CO(TTD-succinyl)₁₂-O-resin (0.5 mmole) for 1 hour with vortex agitation, then drained. Excess reactants and soluble co-products were removed by a 1-minute vortexing flow wash with DMF (˜50 ml), and then drained. The product tertBuOOC—CH(CH3)-NH—OC—CH₂CH₂CO(TTD-succinyl)₁₂-O-resin was washed extensively with DCM, drained and then the resin was dried under vacuum to constant weight. Typical weight of product-resin was around 2 grams.

The linear GRFNP39 was cleaved from the resin support according to standard Fmoc-chemistry procedures using 4% TFA in DCM. The precipitated crude product was dissolved in 50% aqueous acetonitrile containing 0.1% TFA and lyophilized. The lyophilized polymer was dissolved in a small amount of 50% aqueous acetonitrile containing 0.1% TFA and diluted to reduce the concentration of organic below 1%. The crude product was loaded onto a C4 preparative reverse-phase HPLC column equilibrated at T=40° C. at 3% B. Salts were eluted isocratically and the desired template was purified with a linear gradient of 20-35% Buffer B (acetonitrile containing 0.1% TFA) versus 0.1% aqueous TFA over 60 minutes. Fractions containing the desired (Succ-TTD)₁₂-Succ-AlaOtBu material (GRFNP39) were identified by ES-MS, frozen and lyophilized. The structure of GRFNP39 (GP39) is shown below.

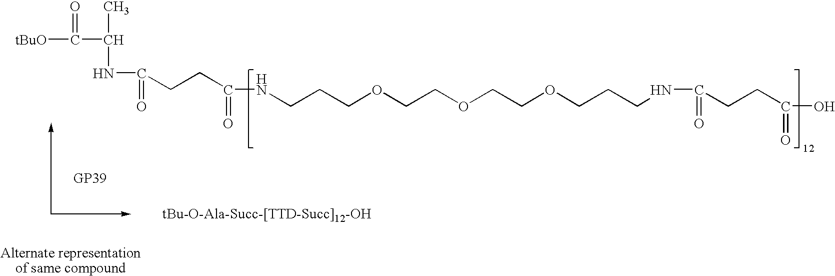

### Example 4

### Synthesis of Branching Template GRFNP42

Branching template GRFNP42 (GP42) was synthesized manually on a Boc-Leu-OCH₂-Pam-resin on a 0.4 mmol scale. A one-minute flow-washing step with DMF was used between every coupling, deprotection and activation step. The Boc group was removed by treatment with neat (i.e. 100%) TFA. After DMF washing, 2 mmol Fmoc-(Rink-linker)-OH was coupled to the resin after activation with 1.8 mmol HBTU in 3.8 ml DMF containing 1 ml DIEA. After removal of the Fmoc protecting group (2×3 minutes 20% piperidine in DMF), 2 mmol Fmoc-Lys(Mtt)-OH was coupled to the resin using NHS-ester activation with 2 mmol DIC and 2 mmol NHS in DMF. After removal of the Fmoc protecting group (2×1 minute 0.5% DBU in DMF), 4 mmol succinic anhydride dissolved in 8 ml of 0.5M HOBT solution containing 2.2 mmol DIEA was coupled to the resin for 10 minutes. After this step, the resin-bound carboxyl group was activated with 8 ml of fresh 0.5 M CDI solution in DMF. 4 ml TTD was added in 4 ml 0.5M HOBT solution and coupled for 30 minutes.

2 mmol Fmoc-Lys(Fmoc)-OH was coupled to the resin using NHS-ester activation with 2 mmol DIC and 2 mmol NHS in DMF. After an Fmoc removal step (2×1 minute 0.5% DBU in DMF), 4 mmol Boc-Lys(Boc)-NHS is coupled in 3 ml DMF.

The MTT protecting group was removed by multiple washes with 2% TFA in DCM. Deprotection was complete when the supernatant lost its yellow color. The resin was neutralized with 10% DIEA in DMF for one minute. 2 mmol pyruvic acid was coupled to the resin using NHS-ester activation with 2 mmol DIC and 2 mmol NHS in DMF for 45 minutes. The template was deprotected and cleaved from the resin support using neat TFA containing 5% water. The cleavage solution was evaporated to dryness in a rotator evaporator. The residue was dissolved in 50% aqueous acetonitrile containing 0.1% TFA and lyophilized. The lyophilized template was dissolved in a small amount of 50% aqueous acetonitrile containing 0.1% TFA and diluted to reduce the concentration of organic below 1%. The pyruvate-containing template was loaded onto a C4 Prep column equilibrated at T=40° C. at 0% Buffer B [i.e. 100% Buffer A=0.1% TFA in water]. Salts were eluted isocratically and the desired template was purified with a linear gradient of 5-12% Buffer B versus 0.1% aqueous TFA in 60 minutes. Fractions containing the desired material (GRFNP42) were identified by ESI-MS, frozen and lyophilized. The structure of GRFNP42 (GP42) is shown below

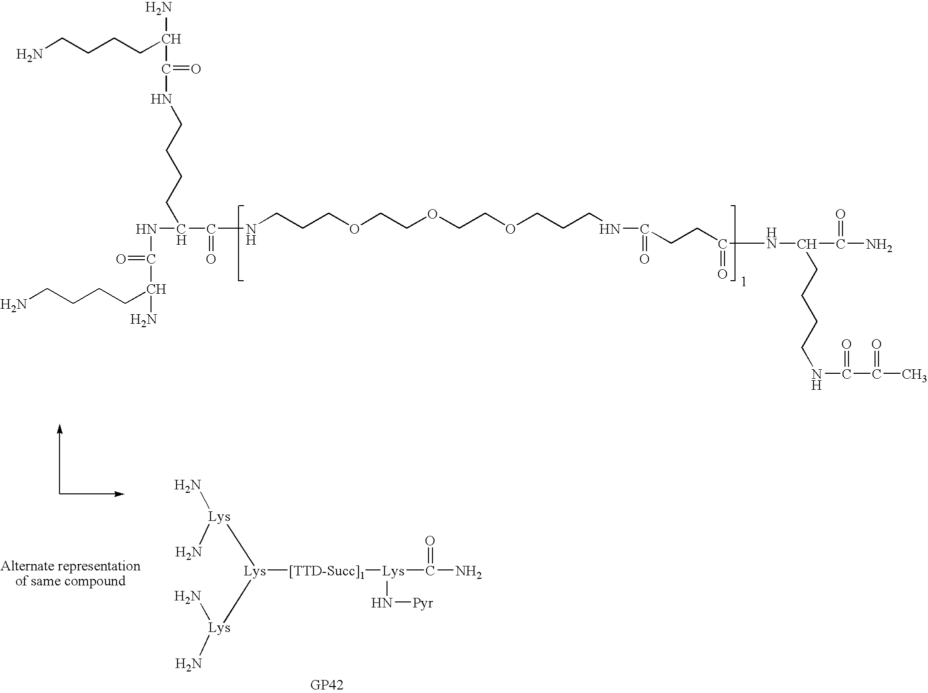

### Example 5

### Assembly of Branched Polymer GRFNP43

GRFNP43, a branched (TTD-Succ)₄₉-polymer of 16 kDa molecular weight was synthesized by coupling GRFNP39 to the purified template GRFNP42. Purified (Succ-TTD)12-Succ-AlaOtBu (GRFNP39) (1.0 mmole) dissolved in DMSO at 60° C. to a concentration of 20 mg/ml was activated with 0.95 mmole of HATU in DMSO at a concentration of 10 mg/ml in the presence of a twenty-fold (molar) excess of DIEA. Purified template (0.24 mmole) GRFNP42 dissolved in DMSO at a concentration of 3.9 mg/ml was added immediately. Progress of the reaction was monitored by analytical C4 reversed-phase HPLC and ES-MS. Typically, the coupling was complete within minutes. For work-up, 4 volumes (relative to reaction mix) 0.1 M acetate/6 M guanidinium chloride, pH 4 was added, and the solution was loaded onto a preparative (C4) reverse-phase HPLC column. Salts and other non-amide containing material were eluted isocratically and the desired product branched polymer was purified with a linear gradient of 20-35% Buffer B (acetonitrile containing 0.1% TFA) versus 0.1% aqueous TFA over 80 minutes. Fractions containing the desired material were identified by ES-MS, frozen and lyophilized.

The resulting purified branched polymer construct GRFNP43 was dissolved in neat TFA at a concentration of 1 mg/ml for 1 hour to remove the Ala-OtBu tertButyl ester protection. The solution was evaporated to dryness in a rotary evaporator and the dried polymer was dissolved in 50% Buffer B (acetonitrile containing 0.1% TFA). The polymer was desalted on a preparative reverse phase HPLC with a step gradient from 15% to 45% Buffer B versus 0.1% aqueous TFA in 80 minutes. Pooled fractions containing the desired material (GRFNP43) were frozen and lyophilized, and the dried powder used for the oximation-forming ligation step.

The structure of the pyruvic acid-functionalized negatively charged branched PLP polymer GRFNP43 (which is referred to interchangeably with “GRFN43(neg)”) is shown below:

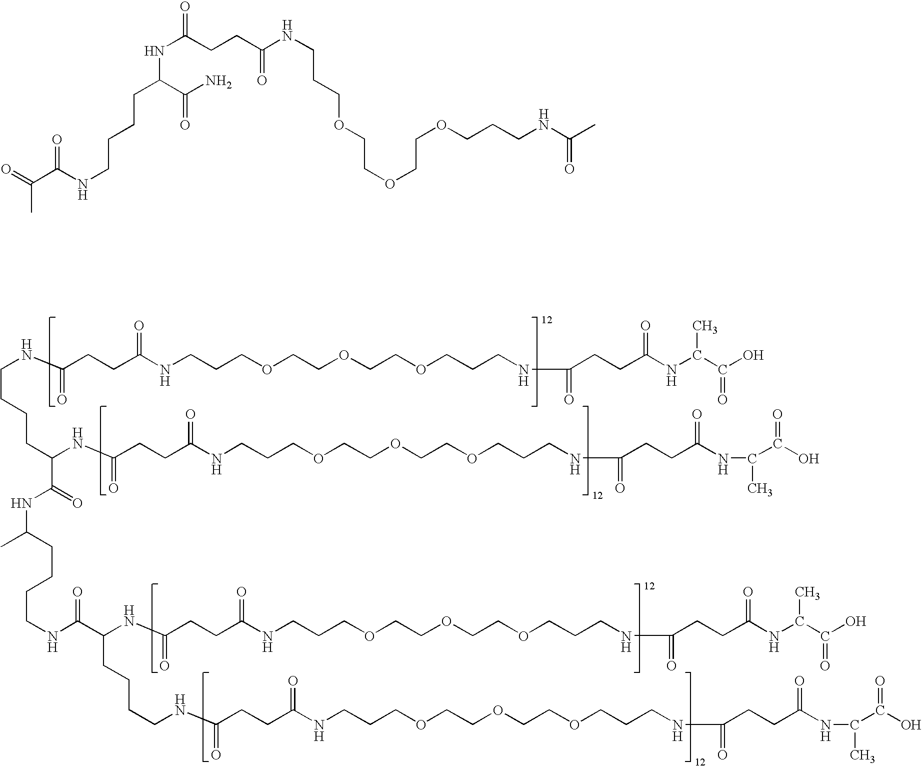

A variant of GRFN43(neg) was also constructed that differs in the net charge imparted by the polymer. This construct (designated “GRFN43(neu)”) was synthesized in the same manner as for GRFN43(neg) except that the linear polymer intermediate employed for final assembly with template GRFNP42 was made to contain an amide terminal group bearing a net neutral charge, as opposed to the alanine of GRFNP39 bearing a net negative charge imparted by the carboxylate. Briefly, a neutral linear PLP polymer containing 12 “Succ-TTD” repeats (designated “GRFNP44”) was made as follows. On a 0.5 mM scale, 400 mg succinic anhydride dissolved in 8 ml of 0.5M HOBT (N-hydroxybenzotriazole) containing 400 ul DIEA was coupled to s-DVB resin (subsitution 0.5 mmol/g) carrying a Rink linker for 10 minutes. The resin was activated with 8 ml of fresh 1 M CDI (Carboxydiimidazole) solution in DMF and 4 mL TTD was added in 4 mL 0.5M HOBT solution coupled for 30 minutes. After twelve cycles, a terminal succinic anhydride group was coupled as described. The resin was cleaved using standard Fmoc procedures, and the linear GRFNP44 polymer was purified by reversed-phase HPLC by a linear gradient. Linear GRFNP44 polymer was then activated and coupled to branching template GRFNP42 as described for GRFN43(neg), to yield the branched GRFN43(neu) polymer. The structure of the pyruvic acid-functionalized neutral branched PLP polymer GRFN43(neu) is shown below:

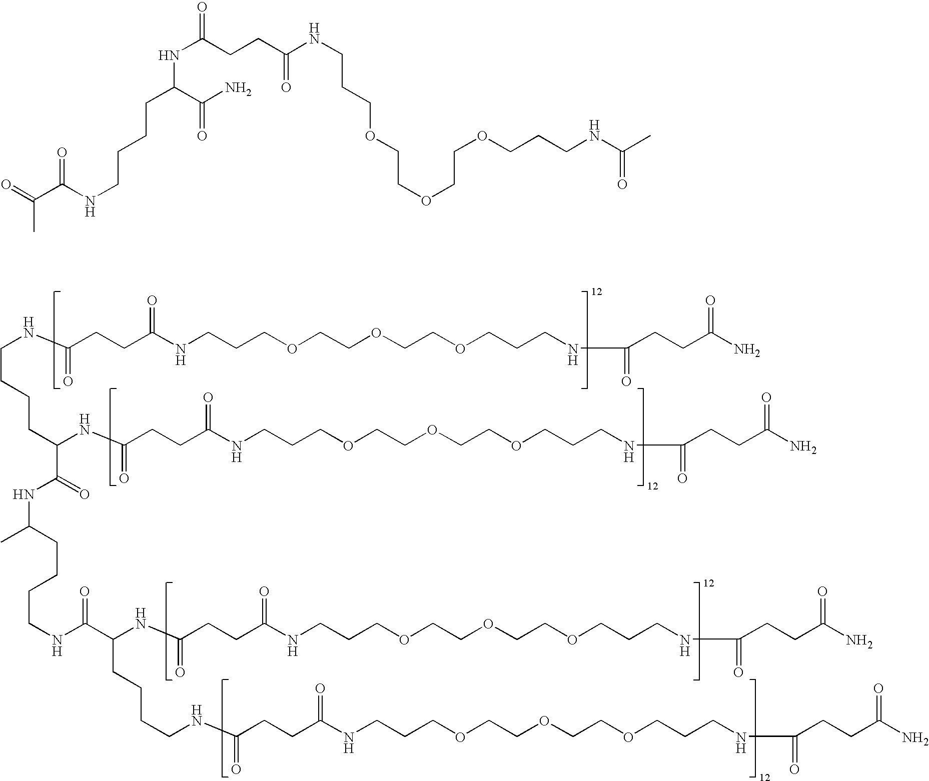

### Example 6

### Synthesis of Peptide Segments SGP-1:4 (GRFN1841) and SGP-1:2 (GRFN1867) for Modification with 2PLP-Levulinyl Oxime Protecting Groups

The following peptide segments were synthesized for constructing polymer-modified peptide segments SGP-1:2 (GRFN 1867) and SGP-1:4 (GRFN1841):
Segment SGP-1:2 (GRFN 1867, composed of residues 36-73 of SEQ ID NO:1):
   CATYK LCHPE ELVLL GHSLG IPK^{AoA}AP LSSCP SQALQ LAG-thioester (where His⁴³ and His⁵² are Bom protected, and Lys⁵⁸ is modified with a aminooxyacetyl group at the 6-amino group denoted by K^{AoA}, and Cys³⁶ is Acm protected).
Segment SGP-1:4 (GRFN 1841, composed of residues 131-174 of SEQ ID NO:1):
   CPK^{AoA}QG AMPAF ASAFQ RRAGG VLVAS HLQSF LEVSY RVLRH LAQP-carboxylate (where His¹⁵⁶ and His¹⁷⁰ are Dnp protected, and Lys¹³³ is modified with a aminooxyacetyl group at the ε-amino group denoted by K^{AoA})

Segment SGP-1:2 (GRFN 1867) was synthesized on a thioester-generating resin, and Segment SGP-1:4 (GRFN 1841) on a —OCH₂-Pam-resin as in Example 1. Lysines 58 and 133 of these two peptide segments were initially protected with an Fmoc group at the ε-amino group. After completion of the chain assembly, the Fmoc-bearing amino groups were deprotected following standard Fmoc deprotection procedures and modified by attachment of aminooxyacetic acid to each peptide resin, respectively. The peptides were then deprotected and simultaneously cleaved from the resin support as described in Example 1. The peptides were purified by preparative C4 reverse phase HPLC. Fractions containing pure peptide were identified using ES-MS, pooled and lyophilized for subsequent ligation.

### Example 7

### Modification of Peptide Segments SGP-1:4 (GRFN1841) and SGP-1:2 (GRFN1867) with 2PLP-Levulinyl Protecting Groups

Oxime formation was performed to attach water-soluble polymers bearing a ketone carbonyl group to peptides carrying an aminooxyacetyl group. Segment SGP-1:4 and segment SGP-1:2, respectively, and 2PLP-levulinyl were jointly dissolved in fresh 50% aqueous acetonitrile respectively. The solution was heated overnight at 40° C. The polymer-modified peptide was separated from unmodified peptide and unreacted polymer by preparative gradient C4 reverse-phase HPLC. Fractions containing the desired oximated product SGP-1:4(2PLP) and SGP-1:2(2PLP), respectively, were identified by ES-MS and pooled and lyophilized.

### Example 8

### Synthesis of Polymer-Modified Synthetic Granulocyte Colony Stimulating Proteins SGP-A, SGP-B and SGP-D

A family of three polymer-modified synthetic granulocyte colony-stimulating proteins (designated SGP-A, SGP-B and SGP-D) was synthesized to contain oxime-forming groups at one or several sites in positions 58 and/or 133. The final structures of SGP-A, SGP-B, and SGP-D are presented in FIGS. 3, 4 and 5, respectively.

SGP-A carries two neutral, branched water-soluble polyamide polymers (“PLP”) at positions 58 and 133. SGP-B is identical to SGP-A except for the substitution of Cys17 by amino-butyric acid. SGP-D is identical to SGP-B, except for the structure and charge of the PLP. The PLP portion of SGP-D adds eight negative charges to SGP-D.

The sequences of the full-length SGP-A, -B and -D polypeptide backbones are as follows:
SGP A (1-174): TPLGP ASSLP QSFLL KCLEQ VRKIQ GDGM LQEKL CATYK LCHPE ELVLL GHSLG IPK^{ox}AP LSSCP SQALQ LAG CLSQL HSGLF LYQGL LQALE GISPE LGPTL DTLQL DVADF ATTIW QQNleEE LGNleAP AL ΨPK^{ox}QG AMPAF ASAFQ RRAGG VLVAS HLQSF LEVSY RVLRH LAQP (SEQ ID NO:1)
SGP B and SGP D (1-174): TPLGP ASSLP QSFLL KAbuLEQ VRKIQ GDGM LQEKL CATYK LCHPE ELVLL GHSLG IPK^{ox}AP LSSCP SQALQ LAG CLSQL HSGLF LYQGL LQALE GISPE LGPTL DTLQL DVADF ATTIW QQNleEE LGNleAP AL ΨPK^{ox} QG AMPAF ASAFQ RRAGG VLVAS HLQSF LEVSY RVLRH LAQP (SEQ ID NO:2)
   where Ψ denotes an non-native amino acid residue consisting of a cysteine that is carboxamidemethylated at the sulfhydryl group, Abu denotes aminobutyric acid, Nle denotes norleucine, and where K^{ox} denotes a non-native lysine that is chemically modified at the ε-amino group with an oxime linker group coupled to a designated water-soluble polymer through an oxime bond (or intermediates which contain AoA).

The polymer-modified synthetic granulocyte colony-stimulating proteins SGP-A, -B, and -D were synthesized in solution from four polypeptide segments:
Segment SGP1A (GRFN 1857; composed of residues 1-35 of SEQ ID NO:1):
   TPLGP ASSLP QSFLL KCLEQ VRKIQ GDGM LQEKL -thioester
Segment SGP1B (GRFN 1864; composed of residues 1-35 of SEQ ID NO:2):
   TPLGP ASSLP QSFLL KAbuLEQ VRKIQ GDGM LQEKL-thioester (where Abu denotes aminobutyric acid)
Segment SGP2(2PLP) (GRFN 1867, composed of residues 36-73 of SEQ ID NO:1):
   CATYK LCHPE ELVLL GHSLG IPK^{ox}AP LSSCP SQALQ LAG -thioester (where Cys³⁶ is Acm protected, His⁴³ and His⁵² are Bom protected, and where Lys⁵⁸ is modified at the ε-amino group with an aminooxyacetyl linker group that is coupled to 2PLP through a levulinic-aminooxycetyl (Lev-AoA) oxime bond denoted K^{ox}.
Segment SGP3 (GRFN 1846, composed of residues 74-130 of SEQ ID NO:1):
   CLSQL HSGLF LYQGL LQALE GISPE LGPTL DTLQL DVADF ATTIW QQNleEE LGNleAP AL-thioester (where Cys⁷⁴ is Acm protected, His⁷⁹ is Dnp protected, Trp¹¹⁸ is formyl protected, and where Nle denotes norleucine)
Segment SGP4(2PLP) (GRFN 1841, composed of residues 131-174 of SEQ ID NO:1):
   CPK^{ox}QG AMPAF ASAFQ RRAGG VLVAS HLQSF LEVSY RVLRH LAQP-carboxylate (where His¹⁵⁶ and His¹⁷⁰ are Dnp protected, Lys¹³³ is modified at the ε-amino group with an aminooxyacetyl linker group that is coupled to 2PLP through a levulinic-aminooxycetyl (Lev-AoA) oxime bond denoted K^{ox}.

A schematic illustrating the chemical synthesis of SGP-A, SGP-B and SGP-D as described below is shown in FIG. 2. Briefly, in FIG. 2, a water-soluble polymer-based protecting group (2PLP) is attached to peptides SGP2 and SGP4 through an oxime bond-forming chemical ligation reaction. As shown, peptide SGP2 bears a C-terminal group at position 73 comprising a glycine alpha-carboxyl thioester for subsequent native chemical ligation. SGP2 carries a non-native lysine residue at position 58 the side chain of which has been chemically modified to bear a group comprising an aminooxy acyl moiety. Peptide SGP4 has an unprotected N-terminal group at position 131 comprising a cysteine, a group comprising an aminooxy acyl modified Lysine at position 133 (corresponding to an O-glycosylation site of natural human G-CSF). Site-specific, and exclusive attachment of the 2PLP-levulynyl polymer protecting group at positions 58 and 133 is achieved through oxime-forming chemical ligation to produce the protected peptide SGP2(2PLP) and SGP4(2PLP). FIG. 2 shows native chemical ligation of SGP4(2PLP) to a middle peptide segment (Acm)SGP3 and generation of (Acm)SGP3+SGP4(2PLP), the ligation site of which is at Leu¹³⁰ and Cys¹³¹. As shown peptide (Acm)SGP3 comprises an N-terminal group at position 74 comprising an Acm protected cysteine, and a C-terminal group at position 130 comprising a leucine alpha-carboxyl thioester. Following native chemical ligation, the-ligation product is exposed to bromoacetamide for carboxamidomethylation of the side chain thiols of ligation site cysteine 131, and thus their conversion to pseudohomoglutamine. Following native chemical ligation, the Acm protecting group is removed to prepare this ligation product for the next ligation reaction. FIG. 2 shows native chemical ligation of SGP3+SGP4(2PLP) to a middle peptide segment (Acm)SGP2(2PLP) and generation of (Acm)SGP2(2PLP)+SGP3+SGP4(2PLP), the ligation site of which is at Gly⁷³ and Cys⁷⁴. As shown peptide (Acm)SGP2 bears an N-terminal group at position 35 comprising an Acm cysteine, and a C-terminal group at position 89 comprising a glycine alpha-carboxyl thioester. Following carboxamidomethylation, the Acm and protecting groups are removed to prepare this polymer-modified ligation product for the next ligation reaction. FIG. 2 shows native chemical ligation of SGP2(2PLP)+SGP3+SGP4(2PLP) to peptide segment SGP1A or SGP1B (corresponding to the N-terminal segment of the desired full length product) and generation of the full length, protected SGP product SGP1A (or 1B)+SGP2(2PLP)+SGP3+SGP4(2PLP), the final ligation site of which is at Leu³⁵ and Cys³⁶. Subsequently, the polymeric 2PLP protecting groups at positions 58 and 133 are removed to yield SGP1A (or 1B)+SGP2(AoA)+SGP3+SGP4(AoA) and the desired polymer constructs are attached by chemoselective oxime-forming ligation between a pyruvic acid group on a selected incoming branched PLP polymer (bPLP) and the aminooxy groups on the full length polypeptide to yield the desired full-length protein-polymer construct SGP1A (or 1B)+SGP2(bPLP)+SGP3+SGP4(bPLP). As shown, the full-length SGP-A, -B and -D products include two water-soluble polymers attached exclusively at user-defined sites, corresponding to position 58 and position 133. The details of the synthesis are described below.

Step 1: Ligation #1 Segment SGP4(2PLP) and a 1.5 fold excess of segment (Acm)SGP3 were dissolved in 200 mM phosphate buffer (pH 7.9) containing 6 M guanidinium chloride at a concentration of 24 mM concentration and 1% thiophenol was added, resulting in a clear solution of the peptide segments. After ligation, 1 equivalent (eq) v/v TFE (trifluoroethanol), 2 eq v/v 6M guanidinium chloride, 100 mM Tris-HCL, pH 8.5 and 1 eq v/v β-mercaptoethanol were added to the ligation mix and incubated for 30 minutes. The solution was acidified with a solution of TCEP (tris(2-carboxyethyl)phosphine.HCl) in 20% aqueous glacial acetic acid and loaded onto a preparative C4 reverse-phase HPLC column (1 inch diameter). The peptides were then purified by preparative gradient reverse-phase HPLC. Fractions containing the desired ligated product (Acm)SGP3+SGP4(2PLP) were identified by ES-MS and pooled.

Step 2: Carboxyamidemethylation (Acm)SGP3+SGP4(2PLP) was dissolved in 200 mM Phosphate buffer (pH 7.9) containing 6 M guanidinium chloride. A 25-fold excess of bromoacetamide (Br—CH₂—C(O)—NH₂) dissolved in methanol at a concentration of 50 mg/ml was added, and the solution was allowed to react for two hours. The solution was loaded onto C4 coated reverse-phase beads and desalted by washing with low organic buffer (15% aqueous isopropanol, 0.1% TFA) followed by elution with high-organic buffer (90% aqueous isopropanol, 0.1% TFA). Fractions containing the desired carboxyamidemethylated (“CM”) product (Acm)SGP3+SGP4(2PLP)(CM) were identified by ES-MS and pooled and lyophilized.

Step 3: Acm-Removal #1 For Acm removal, (Acm)SGP3+SGP4(2PLP)(CM) was dissolved in TFE at a concentration of 20 mg/ml. Alternatively, the reaction was performed in HPLC buffer. The solution was diluted with 4M freshly prepared urea, for a final concentration of peptide of 4 mg/ml and TFE of 20%. A threefold molar excess (relative to the total expected cysteine concentration) of a 30 mg/ml Hg(acetate)₂ solution in 3% aqueous acetic acid was added and the solution is stirred for one hour. The solution was then made 20% in β-mercaptoethanol, and 60% 100 mM acetate, pH4 containing 6M guanidinium chloride. The solution was then desalted as described in step 2, and lyophilized.

Step 4: Ligation #2 SGP3+SGP4(2PLP)(CM) and a 1.5 fold excess of (Acm)SGP2(2PLP) were jointly dissolved in 200 mM Phosphate buffer (pH 7.9) containing 6 M guanidinium chloride at 2-4 mM concentration, and 1% thiophenol was added, resulting in a clear solution of the peptide segments. After one day of ligation, After ligation, 1 equivalent (eq) v/v TFE (trifluoroethanol), 2 eq v/v 6M guanidinium chloride, 100 mM Tris-Hcl, pH 8.5 1 eq v/v piperidine, and 1 eq v/v β-mercaptoethanol were added to the ligation mix and incubated for 30 minutes to remove any remaining protecting groups. The solution was acidified with a solution of TCEP in 20% aqueous acetic acid, loaded onto a preparative reverse-phase HPLC column and purified with a linear gradient. Fractions containing the desired ligated product (Acm)SGP2(2PLP)+SGP3+SGP4(2PLP)(CM) were identified by ES-MS and lyophilized overnight.

Step 5: Acm-Removal #2 The N-terminal Cys(Acm) protecting group of (Acm)SGP2(2PLP)+SGP3+SGP4(2PLP)(CM) was removed by dissolving the peptide in TFE at a concentration of 20 mg/ml. The solution was diluted with 4M freshly prepared aqueous urea, for a final concentration of peptide of 4 mg/ml and TFE of 20%. A threefold molar excess (relative to the total expected cysteine concentration) of a 30 mg/ml Hg(acetate)₂ solution in 3% aqueous acetic acid was added and the solution stirred for one hour. The solution was then made 20% in β-mercaptoethanol, and 60% 100 mM acetate, pH4 containing 6M guanidinium chloride was added. The solution was then desalted as described in step 2 to yield SGP2(2PLP)+SGP3+SGP4(2PLP)(CM).

Step 6: Ligation #3 SGP2(2PLP)+SGP3+SGP4(2PLP)(CM) and a 1.5 fold excess of SGP1A or SGP1B were jointly dissolved at 2-4 mM concentration in 250 mM Phosphate buffer (pH 7.5) containing 6 M guanidinium chloride, and 1% thiophenol was added. After ligation overnight, 1 eq v/v TFE (trifluoroethanol), 2 eq v/v 6M guanidinium chloride, 100 mM Tris-Hcl, pH 8.5 and 1 eq v/v β-mercaptoethanol were added to the ligation mix and incubated for 30 minutes. The solution was acidified with a solution of 15 mg/ml TCEP in 20% aqueous acetic acid, loaded onto a preparative reverse-phase HPLC column and purified with a linear gradient. Fractions containing the desired ligated product SGP1A+SGP2(2PLP)+SGP3+SGP4(2PLP)(CM) (SGP A (1-174)) (SEQ ID NO:1) or SGP1B+SGP2(2PLP)+SGP3+SGP4(2PLP)(CM) (SGP B and D (1-174)) (SEQ ID NO:2) were identified by electrospray mass spectrometry, pooled and frozen for folding.

Step 7 Protecting Group Removal (−2PLP): Aliquots of full-length ligated peptide SGP A, -B and -D (1-174) were thawed and carboxymethoxylamine was added to a final concentration of 0.25M. The mixture was heated to 40 ° C. and the progress of the reaction was monitored by electrospray mass spectrometry. After completion, the reaction mixture was diluted 4× with 30% aqueous acetonitrile, TCEP was added, and the product was separated from the reactants with a linear gradient. Fractions containing the desired products, SGP1A+SGP2(AoA)+SGP3+SGP4(AoA)(CM) (SGP A (1-174)) (SEQ ID NO:1) or SGP1B+SGP2(AoA)+SGP3+SGP4(AoA)(CM) (SGP B and D (1-174)) (SEQ ID NO:2) were identified by electrospray mass spectrometry, pooled and frozen.

Step 8 Oximation with bPLP: 10 molar equivalents (relative to peptide bound aminooxyacetyl groups) of neutral (GRFN43(neu)) and negatively charged (GRFN43(neg)), respectively, were dissolved at a concentration of 50 mg/ml in fresh 50% aqueous acetonitrile containing 0.1% TFA. This stock was added to the pooled SGP fractions from step 7 and lyophilized to dryness. The lyophilized powder was redissolved in a minimal volume of freshly prepared 30% acetonitrile in 6 M guanidinium chloride, pH˜3.5. The progress of the reaction was monitored by reversed-phase HPLC, ESI/MS and SDS/PAGE. After completion, the product was separated from the reactants by reverse phase HPLC with a linear gradient. Fractions containing the desired product, SGP1A+SGP2(bPLP)+SGP3+SGP4(bPLP)(CM) (SGP A (1-174)) (SEQ ID NO:1) or SGP1B+SGP2(bPLP)+SGP3+SGP4(bPLP)(CM) (SGP B and D (1-174)).(SEQ ID NO:2) were identified by electrospray mass spectrometry, pooled and lyophilized.

Step 9 Methionine Reduction: On occasion, methione oxidation was observed during the lyophilization in Step 1. If this occurs, it is necessary to reduce the methionine prior to deprotection, polymer attachment, or folding. All Buffers in contact with SGP from this point on have been pre-purged with He and stored under N₂. The peptide was dissolved in 100 mM acetate, pH 4 containing 6M guanidinium chloride to achieve a 1 mg/ml peptide concentration and 20% v/v NMMA (N-mercaptoacetamide) was added. The reaction mix was heated o/n at 40° C. Progress of the reaction was monitored by reverse phase HPLC and ESI/MS. After the reaction was complete, one equivalent v/v 30% aqueous acetonitrile in 100 mM acetate, pH 4 containing 6M guanidinium chloride and TCEP was added and the product was separated from the reactants by reverse phase HPLC with a linear gradient

Step 10 Folding: An aliquot of full-length ligated peptides SGP-A (1-174) (SEQ ID NO:1), SGP-B (1-174) (SEQ ID NO:2), and SGP-D (1-174) (SEQ ID NO:2) was thawed, saturated with urea, and diluted to a final protein concentration of 0.05 mg/ml. The solution was made 1 mM cysteine, 0.1 mM cystine and 50 mM Tris,pH 8.5. This mixture was then dialyzed O/N against 50 mM Tris, pH 8.5 containing 1M urea, 1 mM cysteine and 0.1 mM cystine. After folding, the proteins were dialyzed against 20 mM acetate, pH 4.6 (SGP-A, SGP-B) or 20 mM Tris, pH 7.5 (SGP-D).

Analytical reverse-phase HPLC chromatogram, an ES-MS spectrum of the folded protein product as well as a CD spectrum demonstrated the presence of folded protein for all three analogs. Stock solutions of SGP-A and SGP-B in 20 mM NaOAc, pH 4.6, and SGP-D in 20 mM Tris, pH 7.5 were typically stored at either −20° C. or −80° C.

### Example 9

### Bioactivity Assay of Synthetic Neutropoiesis Stimulating Proteins

For the in vitro studies, all samples were diluted in culture medium (e.g., for human HL-60 cells (RPMI 1640, 10% FBS (fetal bovine serum), 100 unit/mL Penicillin and 100 pg/mL Streptomycin, and 1.25% Dimethyl Sufoxide (DMSO)) or in Iscove's modified Dulbecco's medium (IMDM), 10% FBS (Fetal bovine serum), glutamine and Penstrep) following standard protocols, and used immediately or kept at 2-8° C. until use.

In particular, the SGP stock solutions were prepared as described above and added to multi-well plates to which NSF 60 or HL 60 cells at a concentration of about 5000 cells/50 μl were added. For HL 60 cells, the cells were induced to differentiate using 1.25% Dimethyl Sufoxide (DMSO). Differentiating HL-60 cells in RPMI 1640 medium, 10% FBS, 1× penicillin/streptomycin 1.25% DMSO and 50 μL were added to 96-well plate at a density of 20000 cells/100 μL with a series of two-fold diluted test compound. The plates were incubated at 37° C. in the presence of 5% CO₂ and monitored daily for growth. After three days, 20 μL CellTiter 96 AQueous One Solution was added, and the absorbance of each well was read at 490 nm. The dose response curves of OD490 nm versus Log concentrations were plotted for the determination of EC50 using Four-Parameter Logestic Function.

For NFS-60 cells, these cells were added to 96-well plates at a concentration of 5000 cells/50 μL (100000 cells/mL) in IMDM medium (G-CSF depleted), 5% FBS, 2 mM glutamine, 1× penicillin/streptomycin, to which 50 μL stock solutions of the test compounds were added in serial 2× dilutions in plain medium. The plates were incubated at 37 ° C. in the presence of 5% CO₂ and monitored daily for growth. After four days, 20 μl of a 2.5 mg/ml MTT (methylthiazol tetrazolium) in PBS (phosphate buffered saline) was added and the plates were incubated for four hours. 150 μl IPA was added and the absorbance of each well was read at 562 nm. Absorbance at 562 nm was corrected for background with no cells. The ED50 (effective dose to reach 50% of maximum effect) values for the SGP compounds was determined and compared to control standards, including recombinant human Met-G-CSF (1-174) produced in E. coli. The results from these experiments demonstrated that all synthetic granulocyte colony-stimulating proteins exhibited bioactivity in both cell lines.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method for producing a chemically-modified compound, said method comprising:
(a) providing a compound bearing one or more water-soluble protecting groups, said water-soluble protecting group comprising a water-soluble polymer; and
(b) replacing one or more of said water-soluble protecting groups of said compound with a chemical adduct to form a chemically-modified compound.

2. The method of claim 1, wherein said compound is selected from the group consisting of a lipid, carbohydrate, nucleic acid, amino acid, peptide, polypeptide, protein and synthetic polymer.

3. The method of claim 1, wherein said chemical adduct is selected from the group consisting of a lipid, carbohydrate, nucleic acid, amino acid, peptide, polypeptide, protein and synthetic polymer.

4. The method of claim 1, wherein said water-soluble protecting group is attached to said compound through a cleavable linker.

5. The method of claim 4, wherein said cleavable linker comprises a covalent bond that is displaceable by said chemical adduct.

6. The method of claim 5, wherein said covalent bond is selected from the group consisting of oxime, hydrazone, diol, thioester, selenoester and disulfide.

7. The method of claim 5, wherein said chemical adduct comprises a reactive functional group capable of displacing said water-soluble protecting group.

8. The method of claim 7, wherein said reactive functional group is selected from the group consisting of aminooxy, diol, aldehyde, ketone, hydrazide, thiol, and selenol.

9. The method of claim 1, wherein said water-soluble protecting group comprises a repeat unit comprising a polyalkylene oxide, a polyamide alkylene oxide, or derivatives thereof.

10. The method of claim 9, wherein said polyalkylene oxide and polyamide alkylene oxide comprise an ethylene oxide repeat unit of the formula —(CH2-CH2-O)—.

11. The method of claim 1, wherein at least one of said water-soluble protecting groups is linear.

12. The method of claim 1, wherein said water-soluble protecting group comprises a net charge under physiological conditions selected from the group consisting of positive, neutral and negative.

13. The method of claim 1, wherein said water-soluble protecting group is mono-disperse.

14. The method of claim 1, wherein said compound is mono-disperse.

15. The method of claim 1, wherein said chemically modified compound is mono-disperse.

16. The method of claim 1, wherein said compound comprises two or more water-soluble protecting groups.

17. The method of claim 16, wherein said water-soluble protecting groups are joined to said compound through the same linkages.

18. A method of producing a library of chemically-modified compounds, said method comprising:
(a) providing a compound bearing one or more water-soluble protecting groups, said water-soluble protecting group comprising a water-soluble polymer;
(b) splitting said compound into first and second reaction systems; and
(c) replacing one or more of said water-soluble protecting groups of said compound in said first reaction system with a first chemical adduct to form a first chemically-modified compound, and, optionally, replacing one or more of said water-soluble protecting groups of said compound in said second reaction system with a second chemical adduct to form a second chemically-modified compound, wherein said first and second chemical adducts are different.

19. A method of producing a chemically-modified ligated polypeptide chain, said method comprising:
(a) providing a first peptide segment bearing one or more water-soluble protecting groups, said water-soluble protecting group comprising a water-soluble polymer;
(b) chemically ligating said first peptide segment to a second peptide segment to form a ligated polypeptide chain bearing one or more of said water-soluble protecting groups; and
(c) replacing one or more of said water-soluble protecting groups with a chemical adduct to form a chemically-modified ligated polypeptide chain.

20. The method of claim 19, wherein said first and second peptide segments comprise non-overlapping amino acid sequences of said polypeptide chain.

21. The method of claim 19, wherein said polypeptide chain comprises an amino acid sequence of a protein, and which further comprises folding said polypeptide chain to form a protein.

22. The method of claim 19, wherein one or more of said peptide segments are partially protected with protecting groups other than said water-soluble protecting group.

23. The method of claim 19, wherein one or more of said peptide segments are unprotected other than with said water-soluble protecting group.

24. The method of claim 19, wherein said chemically ligating comprises a chemoselective ligation chemistry selected from native chemical ligation, extended native chemical ligation, pseudo native chemical ligation, oxime forming chemical ligation, hydrazone forming chemical ligation, oxazolidine forming chemical ligation, thaizolidine forming chemical ligation, and thioester forming chemical ligation.

25. A method of producing a library of chemically-modified ligated polypeptide chains, said method comprising:
(a) providing a first peptide segment bearing one or more water-soluble protecting groups, said water-soluble protecting group comprising a water-soluble polymer;
(b) chemically ligating said first peptide segment to a second peptide segment to form a ligated polypeptide chain bearing one or more of said water-soluble protecting groups;
(c) splitting said ligated polypeptide chain into first and second reaction systems; and
(d) replacing one or more of said water-soluble protecting groups of said ligated polypeptide chain in said first reaction system with a first chemical adduct to form a first chemically-modified ligated polypeptide chain, and, optionally, replacing one or more of said water-soluble protecting groups of said ligated polypeptide chain in said second reaction system with a second chemical adduct to form a second chemically-modified ligated polypeptide chain, wherein said first and second chemical adducts are different.

26. A kit comprising first and second containers, said first container comprising a compound bearing one or more water-soluble protecting groups, said water-soluble protecting group comprising a water-soluble polymer, said second container comprising a chemical adduct capable of replacing one or more of said water-soluble protecting groups of said compound in said first container.
